(19) United States
(12) Patent Application Publication
(10) Pub. No.: US 2012/0274185 A1
(43) Pub. Date: Nov. 1, 2012

(54) MOTOR ROTOR AND MOTOR

(75) Inventors: Ryojiro KANEMITSU, Obu-shi (JP); Takehide NAKAMURA, Handa-shi (JP)

(73) Assignee: AISAN KOGYO KABUSHIKI KAISHA, Obu-shi (JP)

(21) Appl. No.: 13/452,296

(22) Filed: Apr. 20, 2012

(30) Foreign Application Priority Data
Apr. 27, 2011 (JP) 2011-099804

(51) Int. Cl. H02K 11/00; H02K 21/12

(52) U.S. Cl. 310/68 B; 310/156.01

(57) ABSTRACT

A motor with rotation detector includes a rotary shaft, a core part placed around the shaft and provided with axially extending through holes, permanent magnets individually mounted in the through holes, a pair of end plates provided at both ends of the core part to close openings of the through holes, and a motor stator including a coil. The end plates are made of a non-magnetic substance. One of the end plates is provided, on its outer surface in an axial direction, with recesses and protrusions for angle detection alternately arranged in a circumferential direction. A sensor stator with an excitation coil to which a high frequency signal is inputted is located to face the recesses and protrusions of the outer surface of the end plate.

### CROSS-REFERENCE TO RELATED APPLICATIONS

This application is based upon and claims the benefit of priority from the prior Japanese Patent Application No. 2011-099804 filed on Apr. 27, 2011, the entire contents of which are incorporated herein by reference.

### TECHNICAL FIELD

The present invention relates to a motor rotor for use in a motor including a rotation detector and a motor including the motor rotor.

### BACKGROUND ART

Conventionally, this type of technique is known as a brushless motor disclosed for example in JP 2010-48775A. This brushless motor includes a motor rotor and a motor stator and separately therefrom a resolver serving as a rotation detector.

### DISCLOSURE OF THE INVENTION

### Problems to be Solved by the Invention

However, the brushless motor disclosed in JP 2010-48775A needs to have the resolver mounted separately from the motor rotor and the motor stator. This additionally needs a rotor and a stator to constitute the resolver. For this end, the number of parts or components to constitute the entire configuration is increased by the number of parts of the resolver, leading to an increase in the number of steps of assembling the components or parts.

The present invention has been made in view of the circumstances and has a purpose to provide a motor rotor and a motor, including a rotation detector part of components of which is omitted to reduce the number of components of an entire motor equipped with rotation detector and the number of steps of manufacturing the motor.

### Means of Solving the Problems

(1) To achieve the above purpose, one aspect of the invention provides a motor rotor comprising: a rotary shaft; a core part placed around the rotary shaft and provided with a plurality of through holes each extending in an axial direction; a plurality of permanent magnets individually mounted in the through holes; and a pair of end plates provided on both ends of the core part to close openings of the through holes, wherein the end plates are made of a non-magnetic substance, and at least one of the end plates has an outer surface in an axial direction provided with recesses and protrusions for angle detection alternately arranged in a circumferential direction.

(2) To achieve the above purpose, another aspect of the invention provides a motor including the aforementioned motor rotor and a motor stator including a coil, wherein the motor comprises a detector including an excitation coil to which a high frequency signal is inputted, the detector being placed in a position to face the recesses and the protrusions of the outer surface of the end plate of the motor rotor in the axial direction.

### Effects of the Invention

According to the above configuration (1), it is possible to omit part of components of a rotation detector to reduce the number of components of an entire motor equipped with rotation detector and the number of steps of manufacturing the motor.

According to the above configuration (2), it is possible to omit part of components of a rotation detector to reduce the number of components of an entire motor equipped with rotation detector and the number of steps of manufacturing the motor. Further, a sensor rotor can have a good compatibility with a rotation detector including an excitation coil to be excited with a high-frequency signal.

### BRIEF DESCRIPTION OF THE DRAWINGS

FIG. 1 is a cross-sectional view showing a motor equipped with rotation detector in a first embodiment;

FIG. 2 is a side view showing an end face of a rotor core in the first embodiment;

FIG. 3 is a block diagram showing an electric configuration of a rotation detector in the first embodiment;

FIG. 4 is an exploded perspective view showing a sensor stator in the first embodiment;

FIG. 5 is an enlarged exploded perspective view showing part of components in FIG. 4 in the first embodiment;

FIGS. 6A, 6B, and 6C are plan views of part of the components shown in FIG. 5 in the first embodiment;

FIG. 7 is a perspective view of a sensor rotor in the first embodiment;

FIG. 8 is a plan view of the sensor rotor in the first embodiment;

FIGS. 9A to 9D are graphs showing operations and characteristics of the rotation detector in the first embodiment;

FIG. 10 is a cross-sectional view showing actions of a portion of the sensor rotor of FIG. 9A provided with a recess in the first embodiment;

FIG. 11 is a cross-sectional view showing actions of a portion of the sensor rotor of FIG. 9A provided with a protrusion in the first embodiment;

FIG. 12A is a plan view showing an example of a sine wave coil in the first embodiment;

FIG. 12B is a plan view showing an example of a cosine wave coil in the first embodiment;

FIG. 13A is a graph showing, in a wave shape, a magnitude of induced voltage that may occur in the entire sine wave coil in the first embodiment;

FIG. 13B is a graph showing, in a wave shape, a magnitude of induced voltage that occur in the entire cosine wave coil in the first embodiment;

FIG. 14 is a graph showing relationships of electric angle and mechanical angle with respect to each output value of the sine wave coil and the cosine wave coil when a magnetic flux is generated in a predetermined direction in the first embodiment;

FIG. 15A is a plan view showing a positional relationship between the sine wave coil and the protrusion at a rotor angle in FIG. 14 in the first embodiment;

FIG. 15B is a plan view showing a positional relationship between the cosine wave coil and the protrusion at the rotor angle in FIG. 14 in the first embodiment;

FIG. 16A is a plan view showing a positional relationship between the sine wave coil and the protrusion at another rotor angle in FIG. 14 in the first embodiment;

FIG. 16B is a plan view showing a positional relationship between the cosine wave coil and the protrusion at the another rotor angle in FIG. 14 in the first embodiment;

FIG. 17 is a graph showing experimental data on output voltage of the rotation detector in the first embodiment;

FIG. 18 is a plan view showing a sensor stator in a second embodiment;

FIGS. 19A, 19B, and 19C are plan views showing part of components in FIG. 18 in the second embodiment;

FIG. 20 is a perspective view of a sensor rotor in the second embodiment;

FIG. 21 is a plan view of the sensor rotor in the second embodiment;

FIG. 22 is a conceptual diagram showing a developed configuration of a rotation detector in a third embodiment;

FIG. 23 is a block diagram showing a circuit configuration of the rotation detector in the third embodiment;

FIG. 24 is a cross-sectional view showing a motor equipped with rotation detector in a fourth embodiment;

FIG. 25 is an enlarged cross-sectional view of a rotation detector in the fourth embodiment;

FIG. 26 is an enlarged perspective view of a bearing in the fourth embodiment;

FIG. 27 is a cross-sectional view showing a motor equipped with rotation detector in a fifth embodiment; and

FIG. 28 is a cross-sectional view showing a motor equipped with rotation detector in a sixth embodiment.

### MODE FOR CARRYING OUT THE INVENTION

### First Embodiment

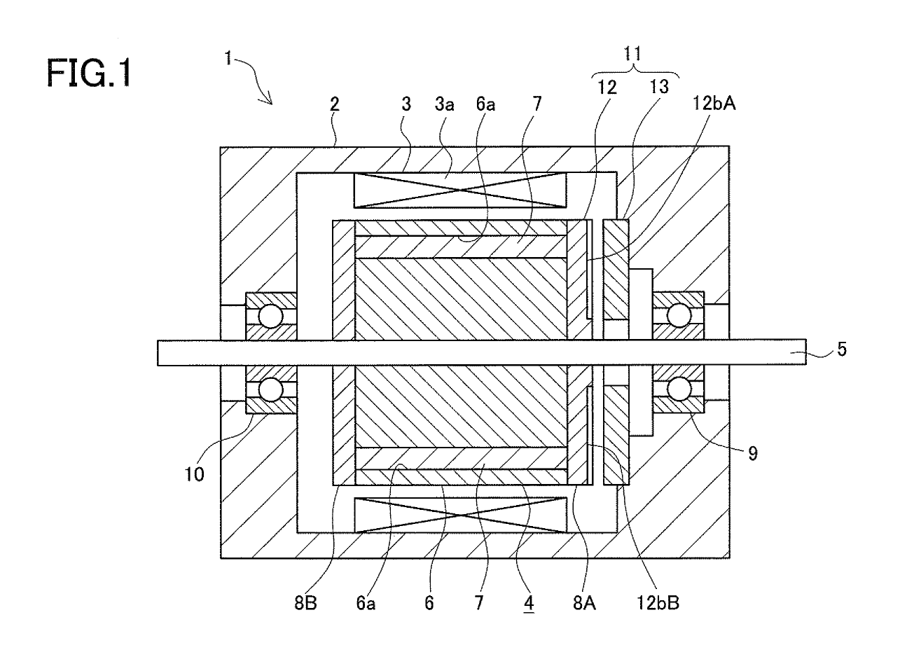

A detailed description of a preferred embodiment of a motor rotor and a motor embodying the present invention will now be given referring to the accompanying FIGS. 1 to 17.

FIG. 1 is a cross-sectional view showing a motor equipped with rotation detector (hereinafter, simply referred to as a “motor”). As shown in FIG. 1, a motor 1 includes a motor case 2, a motor stator 3 and a motor rotor 4 both being provided in the motor case 2, and a motor shaft 5 serving as a rotary shaft integrally provided in the center of the motor rotor 4. Both end portions of the motor shaft 5 protrude out of the motor case 2.

The motor stator 3 is fixed on the inner peripheral surface of the motor case 2. This stator 3 includes a stator core (not shown) and a coil 3a. The motor rotor 4 is placed inside the stator 3 and around the motor shaft 5. This rotor 4 includes a rotor core 6 as a core part formed with a plurality of through holes 6a each extending in an axial direction, a plurality of permanent magnets 7 individually mounted in the through holes 6a, and a pair of a first end plate 8A and a second end plate 8B placed at both ends of the rotor core 6 to close openings of the through holes 6a. The first end plate 8A and the second end plate 8B are made of a non-magnetic conductive material which is a non-magnetic substance.

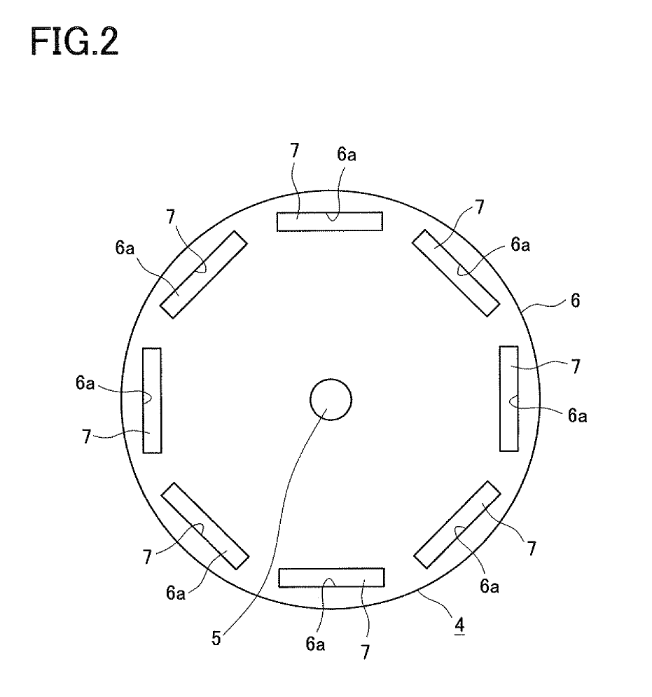

FIG. 2 is a side view showing an end face of the rotor core 6. This rotor core 6 is columnar and formed with a plurality of through holes 6a located near the outer peripheral portion of the core 6 and arranged circumferentially around the motor shaft 5 at equal angular intervals. The permanent magnets 7 are individually accommodated in the through holes 6a. As shown in FIG. 1, the motor shaft 5 is rotatably supported by bearings 9 and 10 provided on both end portions of the motor case 2.

This motor 1 is configured such that, when the coil 3a of the motor stator 3 is excited and the permanent magnets 7 in the motor rotor 4 receive a magnetic force, the motor rotor 4 is rotated together with the motor shaft 5.

In the motor case 2, as shown in FIG. 1, a rotation detector 11 is provided in correspondence with one end (a right end in the figure) of the motor rotor 4. This rotation detector 11 includes a sensor rotor 12 and a sensor stator 13. In the present embodiment, the sensor rotor 12 consists of the first end plate 8A of the motor rotor 4. The sensor stator 13 serving as a detector is fixed inside the motor case 2. The sensor stator 13 is placed to face an outer surface of the sensor rotor 12 in the axial direction with a predetermined gap therefrom.

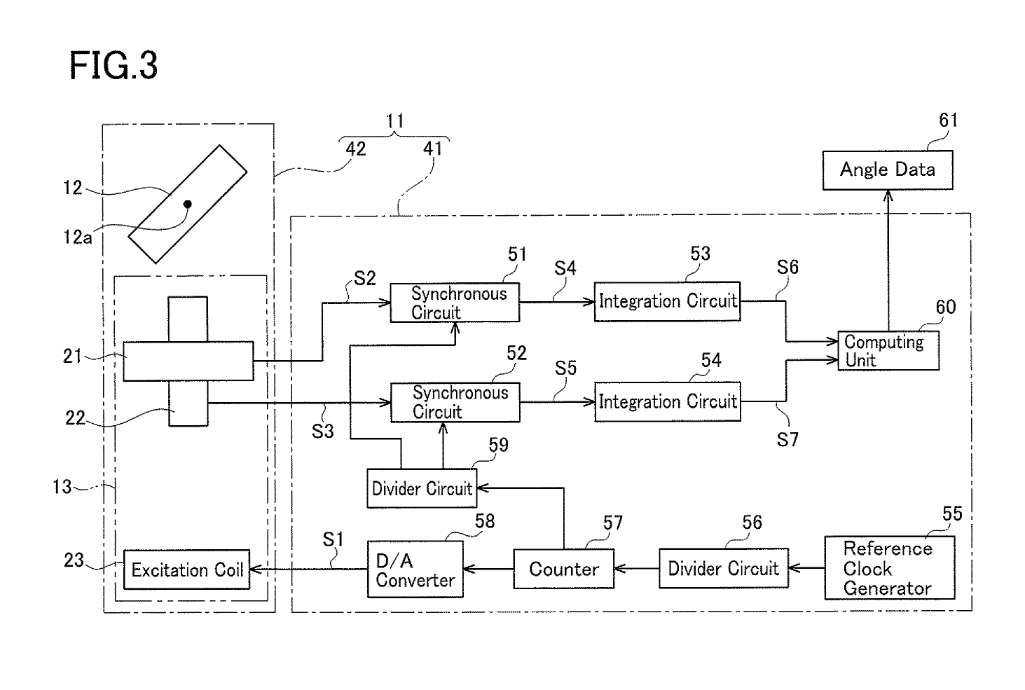

FIG. 3 is a block diagram showing an electric configuration of the rotation detector 11. This detector 11 schematically includes a circuit section 41 and a sensor section 42. The circuit section 41 includes various kinds of circuits and others 51 to 60 as shown in FIG. 3. Specifically, a reference clock generator 55 is connected to a divider circuit 56. This divider circuit 56 is connected to a counter 57. The counter 57 is connected to a D/A converter 58 and another divider circuit 59. This divider circuit 59 is connected to a synchronous detector 51 for sine wave and a synchronous detector 52 for cosine wave. The sine-wave synchronous detector 51 is connected to an integration circuit 53 for sine wave. The cosine-wave synchronous detector 52 is connected to an integration circuit 54 for cosine wave. Those integration circuits 53 and 54 are connected to a computing unit 60. This computing unit 60 outputs a computing result in the form of angle data 61.

As shown in FIG. 3, the sensor section 42 includes the sensor rotor 12 and the sensor stator 13. The sensor stator 13 includes a sine wave coil 21, a cosine wave coil 22, and an excitation coil 23. The sine wave coil 21 is connected to the sine-wave synchronous detector 51 of the circuit section 41. The cosine wave coil 22 is connected to the cosine-wave synchronous detector 52 of the circuit section 41. The excitation coil 23 is connected to the D/A converter 58 of the circuit section 41. The sensor rotor 12 is not electrically connected to any circuits.

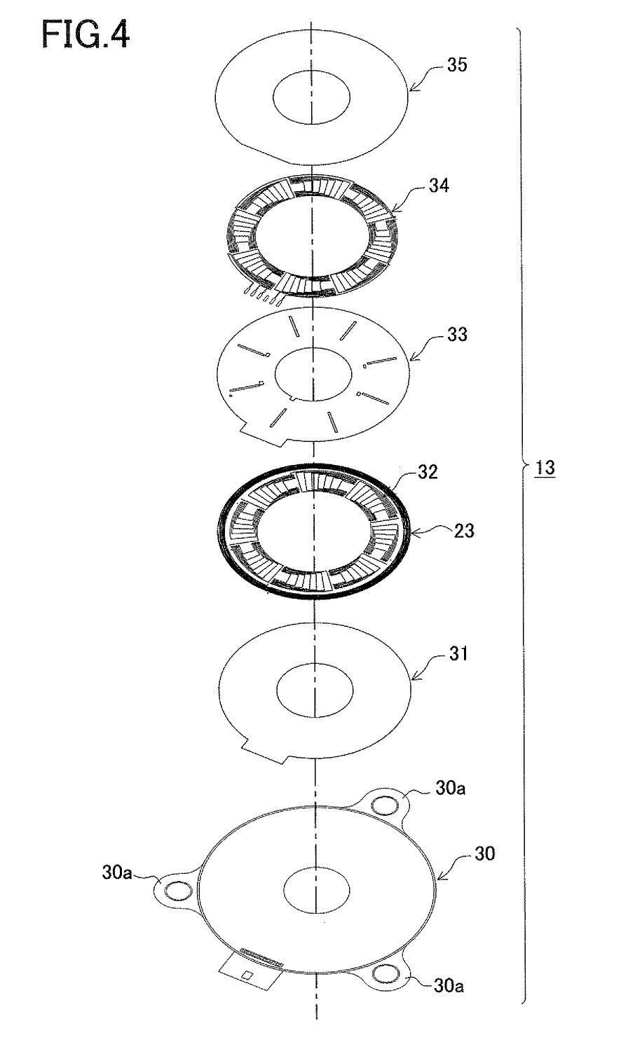

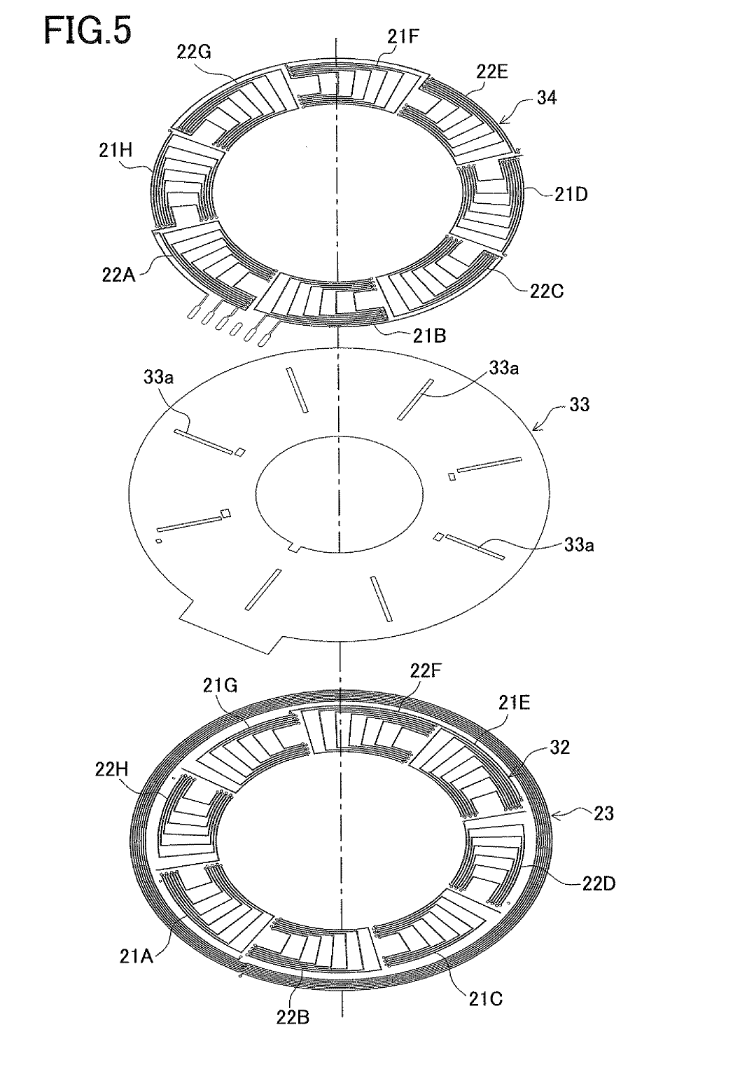

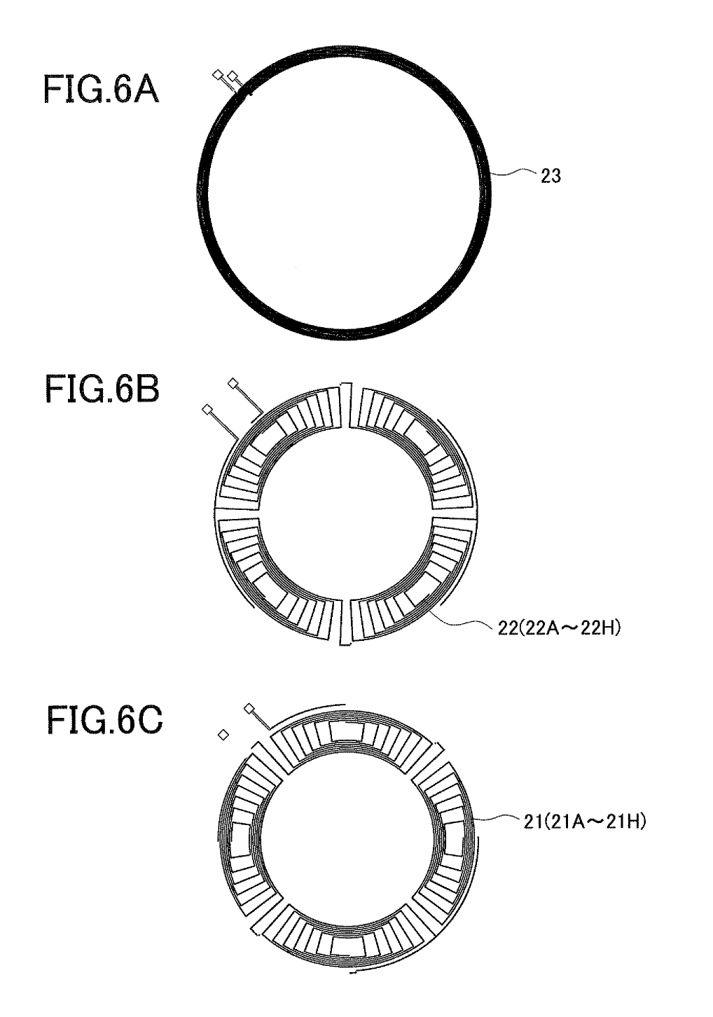

A configuration of the sensor stator 13 will be explained below in detail. FIG. 4 is an exploded perspective view of the sensor stator 13. FIG. 5 is an enlarged exploded perspective view of part of components in FIG. 4. FIGS. 6A to 6C are plan views individually showing part of the components in FIG. 5.

As shown in FIG. 4, the sensor stator 13 includes a base flat plate 30, an insulating layer 31, the excitation coil 23, a first detection coil 32, an insulating layer 33, a second detection coil 34, and an insulating layer 35, which are laminated one on another. The base flat plate 30 located in a lowermost layer has an approximately annular plate-like shape and is formed with a plurality of mounting parts 30a each protruding radially outward. The insulating layer 31 having an approximately annular shape is formed on the base flat plate 30. On the insulating layer 31, the excitation coil 23 and the first detection coil 32 are formed in the same layer. On those excitation coil 23 and first detection coil 32, the insulating layer 33 having an approximately annular shape is formed. Further, the second detection coil 34 is formed on the insulating layer 32. Still further, the insulating layer 35 having an approximately annular shape is formed on the second detection coil 34.

As shown in FIGS. 4 and 5, the first detection coil 32 and the second detection coil 34 are located separately in two layers by interposing therebetween the insulating layer 33. These detection coils 32 and 34 constitute one detection coil. Each of the detection coils 32 and 34 includes flat coil patterns wound in a forward direction and flat coil patterns wound in a reverse direction opposite to the forward direction so that the coil patterns in the forward direction and the coil patterns in the reverse direction are alternately arranged.

To be more specific, as shown in FIG. 5, the first detection coil 32 includes flat coil patterns, i.e., eight split-coil segments 21A, 22B, 21C, 22D, 21E, 22F, 21G, and 22H circumferentially arranged at 45° intervals. In other words, the first detection coil 32 includes the sine-wave split-coil segment 21A, cosine-wave split-coil segment 22B, sine-wave split-coil segment 21C, cosine-wave split-coil segment 22D, sine-wave split-coil segment 21E, cosine-wave split-coil segment 22F, sine-wave split-coil segment 21G, and cosine-wave split-coil segment 22H which are arranged in turn. The insulating layer 33 is formed with eight through holes 33a circumferentially arranged at equal angular intervals, each of which extends radially outward.

As shown in FIG 5, the second detection coil 34 includes flat coil patterns, i.e., eight split-coil segments 22A, 21B, 22C, 21D, 22E, 21F, 22G, and 21H circumferentially arranged at 45° intervals. In other words, in the second detection coil 34, the cosine-wave split-coil segment 22A is placed in a position corresponding to the sine-wave split-coil segment 21A of the first detection coil 32, and the sine-wave split-coil segment 21B is placed in a position corresponding to the cosine-wave split-coil segment 22B of the first detection coil 32. Similarly, the cosine-wave split-coil segment 22C, sine-wave split-coil segment 21D, cosine-wave split-coil segment 22E, sine-wave split-coil segment 21F, cosine-wave split-coil segment 22G, and sine-wave split-coil segment 21H are arranged in turn.

The eight sine-wave split-coil segments 21A to 21H of the first detection coil 32 and second detection coil 34 are connected to each other through the through holes 33a of the insulating layer 33 by winding a wire to alternately go to and fro between the first detection coil 32 and the second detection coil 34 to form four coil parts constituting one sine wave coil 21 shown in FIG. 6C. Herein, two sine-wave split-coil segments 21B and 21C constitute a first sine wave coil 21BC, two sine-wave split-coil segments 21D and 21E constitute a second sine wave coil 21DE, two sine-wave split-coil segments 21F and 21G constitute a third sine wave coil 21FG, and two sine-wave split-coil segments 21H and 21A constitute a fourth sine wave coil 21HA. The winding direction of the first sine wave coil 21BC and the third sine wave coil 21FG is opposite to the winding direction of the second sine wave coil 21DE and the fourth sine wave coil 21HA to generate induced currents in opposite directions with respect to magnetic fluxes in the same direction.

Similarly, the eight cosine-wave split-coil segments 22A to 22H of the first detection coil 32 and second detection coil 34 are connected to each other through the through holes 33a of the insulating layer 33 by winding a wire to alternately go to and fro between the first detection coil 32 and the second detection coil 34 to form four coil parts constituting one cosine wave coil 22 shown in FIG. 6B. Herein, two cosine-wave split-coil segments 22A and 22B constitute a first cosine wave coil 22AB, two cosine-wave split-coil segments 22C and 22D constitute a second cosine wave coil 22CD, two cosine-wave split-coil segments 22E and 22F constitute a third cosine wave coil 22EF, and two cosine-wave split-coil segments 22G and 22H constitute a fourth cosine wave coil 22GH. The winding direction of the first cosine wave coil 22AB and the third cosine wave coil 22EF is opposite to the winding direction of the second cosine wave coil 22CD and the fourth cosine wave coil 22GH to generate induced currents in opposite directions with respect to magnetic fluxes in the same direction. With the above configuration, the sine wave coil 21 and the cosine wave coil 22 are formed with a displacement of 45° from each other.

As shown in FIG. 5, the excitation coil 23 is formed of a flat coil pattern wound in a planar shape surrounding the first detection coil 32, i.e., the flat coil patterns in the forward direction and the flat coil patterns in the reverse direction. The excitation coil 23 is made of a conductive wire circularly wound in multiple turns. The first detection coil 32 and the excitation coil 23 are provided in the same layer between two insulating layers 31 and 33. In the present embodiment, specifically, the excitation coil 23 and the detection coils 32 and 34 are laminated on the base flat plate 30. Further, the excitation coil 23 and the first detection coil 32 which is a part of the detection coil are formed in the same layer. To the excitation coil 23, a high frequency signal will be inputted.

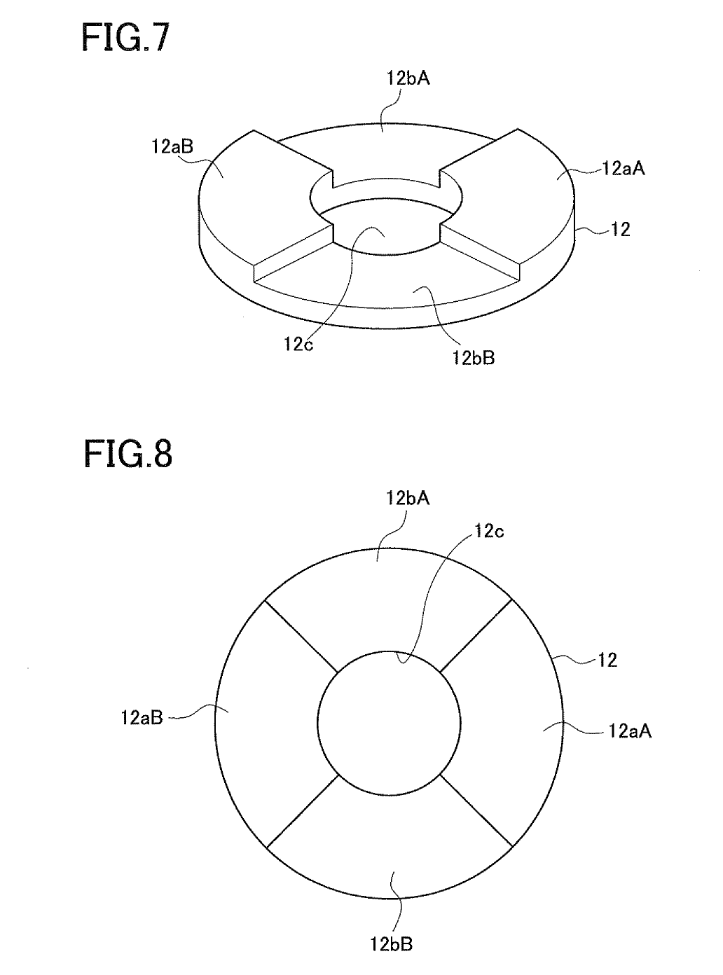

A configuration of the sensor rotor 12 will be explained below. FIG. 7 is a perspective view of the sensor rotor 12. FIG. 8 is a plan view of the sensor rotor 12. The sensor rotor 12 consisting of the first end plate 8A is made of a non-magnetic conductive material such as “SUS305 (JIS)” for example. The sensor rotor 12 is formed, in an outer surface (an upper surface in FIG. 7) in an axial direction, with protrusions and recesses for angle detection that are circumferentially alternately arranged. These protrusions and recesses are defined by circumferential surfaces and vertical surfaces to the circumferential direction in the sensor rotor 12. Specifically, the sensor rotor 12 is provided with protrusions 12aA and 12aB in two sections of the outer surface of a circular flat plate and recesses 12bA and 12bB in other two sections. The protrusions 12aA and 12aB in the two diametrically opposite sections and the recesses 12bA and 12bB in the two diametrically opposite sections are located at angular intervals of 90° from adjacent ones. In other words, in the sensor rotor 12, the recesses 12bA and 12bB are formed at a predetermined angular interval (herein, at an angular interval of 180°) in the circumferential direction. In the present embodiment, when the maximum thickness of the sensor rotor 12 is assumed to for example 10 mm, the height of each protrusion 12aA and 12aB can be set to for example about 2 mm to 3 mm.

In the sensor rotor 12 including four sections divided at 90° intervals, the recesses 12bA and 12bB are arranged in opposite two sections and the protrusions 12aA and 12aB are arranged in other opposite two sections. Further, the sine wave coil 21 and the cosine wave coil 22 of the sensor stator 13 are configured so that split-coil segments 21A to 21H and 22A to 22H are arranged in eight sections divided at 45° intervals. This constitutes a 2×-detection coil.

The sensor rotor 12 is press-fitted on the outer periphery of the motor shaft 5 inserted in the center hole 12c formed at the center of the sensor rotor 12, while the sensor rotor 12 is fixed to serve as the first end plate 8A to the end face of the rotor core 6.

The sensor rotor 12 in the present embodiment is made of a material “SUS305”, but may be made of a different material such as “SUS304”, aluminum, and brass, as long as the material is a non-magnetic conductive material.

With the above configuration, when a high frequency signal is inputted in the excitation coil 23, the detection coils 32 and 34 of the sensor stator 13 output an electromotive force representing changes in magnetic flux that changes at a position of each of the protrusions and recesses of the sensor rotor 12. Each of the detection coils 32 and 34 of the sensor stator 13 include the forward-winding coils each being a flat coil pattern wound in a planar shape in the forward direction and the reverse-winding coils each being a flat coil pattern wound in a planar shape in the reverse direction. The forward-winding coils and the reverse-winding coils are arranged alternately adjacently in the circumferential direction. The total of the widths of the forward-winding coils and the widths of the reverse-windings coil substantially corresponds to one cycle of the protrusion or the recess of the sensor rotor 12. Each of the forward-winding coils and the reverse-winding coils includes a plurality of turns so that the number of turns (wire portions) in each coil changes in a circumferential direction by increasing and decreasing like a sinusoidal waveform. Further, the protrusions and recesses of the sensor rotor 12 are configured so that the distance from the excitation coil 23 of the sensor stator 13 is changed like a sinusoidal waveform. Thus, the sensor stator 13 detects a rotation angle of the motor rotor 4 and the motor shaft 5 based on an inductance change of the excitation coil 23.

Operations of the rotation detector 11 are explained below. In FIG. 3, the reference clock generator 55 generates a reference clock of a high frequency of 32 MHz. The divider circuit 56 is also called a frequency-dividing circuit and arranged to convert a high-frequency clock generated in the reference clock generator 55 into a low-frequency clock. The divider circuit 56 converts the reference clock of 32 MHz to a 500 kHz frequency. The counter 57 counts sixty-four pulses and outputs the sixty-four pulses as one cycle to the D/A converter 58. The D/A converter 58 amplitude-modulates the sixty-four pulses as one cycle to generate a sine wave excitation signal S1 of 7.8125 kHz (500 kHz/64) to excite the excitation coil 23. When the excitation coil 23 is energized by the sine wave excitation signal S1, a magnetic field is generated in the excitation coil 23, thereby generating detection signals which are induced voltage in the sine wave coil 21 and the cosine wave coil 22 both serving as detection coils. This action will be explained in detail later.

In FIG. 3, in response to a count value from the counter 57, another divider circuit 59 transmits detection timing signals to the two synchronous detectors 51 and 52 at necessary timing. The synchronous detector 51 for sine wave reads the detection signal S2 transmitted from the sine wave coil 21 at the timings of the divider circuit 59, that is, synchronously detects the detection signal and transmits a synchronous detection signal S4 to the integration circuit 53. This integration circuit 53 smoothes the output of the synchronous detector 51. An output signal S6 from the integration circuit 53 is transmitted to the computing unit 60. The reason why the synchronous detection and integration are performed herein is that, since a carrier wave of 500 kHz is amplitude-modulated to produce a signal wave of 7.8125 kHz in the present embodiment, the detection signal includes a frequency component of the carrier wave. To remove the frequency component of the carrier wave from the detection signal, accordingly, the synchronous detection and integration are performed.

Similarly, in FIG. 3, the synchronous detector 52 for cosine wave reads a detection signal S3 transmitted from the cosine wave coil 22 at the timings of the divider circuit 59, that is, synchronously detects the detection signal and transmits a synchronous detection signal S5 to the integration circuit 54. This integration circuit 54 smoothes the output of the synchronous detector 52. The function of the integration circuit 54 is equal to that of the integration circuit 53. An output signal S7 of the integration circuit 54 is transmitted to the computing unit 60.

In FIG. 3, the computing unit 60 then calculates a ratio between the output of the sine wave coil 21, transmitted from the integration circuit 53, and the output of the cosine wave coil 22, transmitted from the integration circuit 54, and outputs a calculated ratio as the angle data 61. In the amplitude-type rotation detector 11, the ratio at an electric angle at a certain moment between the output of the sine wave coil 21 via the integration circuit 53 and the output of the cosine wave coil 22 via the integration circuit 54 uniquely corresponds to the electric angle. Therefore, when the ratio is obtained as the angle data 61, a current rotation angle of the sensor rotor 12 can be measured.

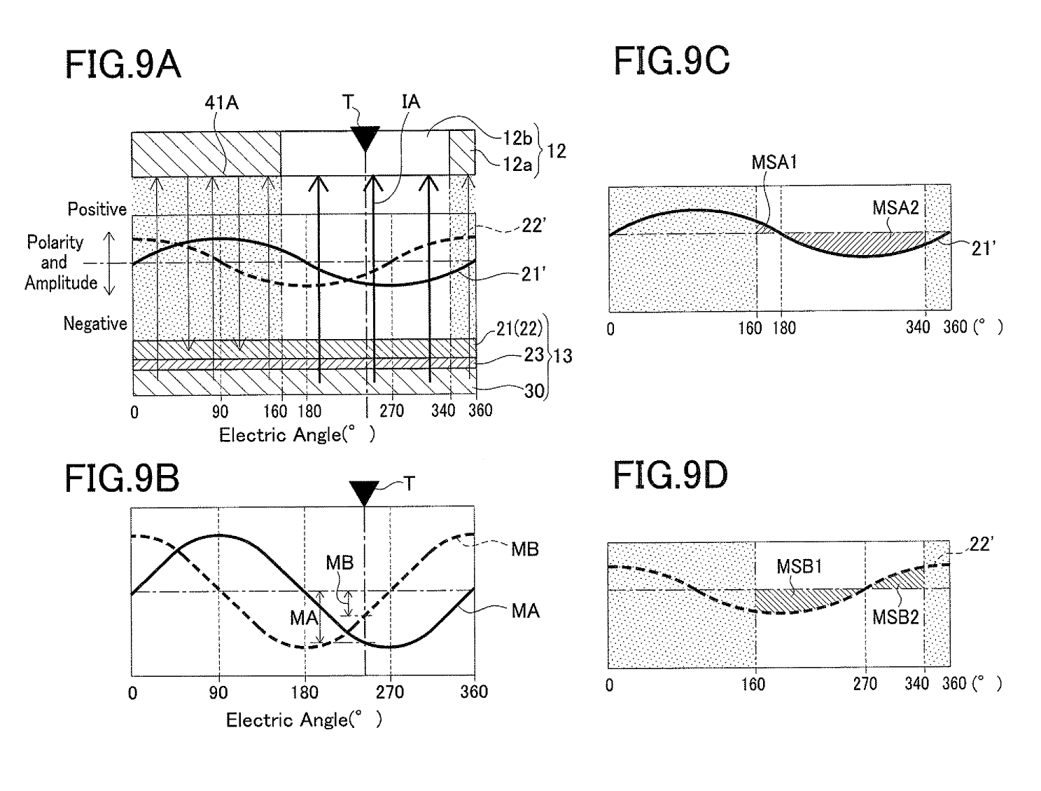

Operations of the excitation coil 23, sensor rotor 12, sine wave coil 21, and cosine wave coil 22 will be explained below. FIGS. 9A to 9D are graphs showing operations and characteristics of the rotation detector 11. FIG. 9A is a graph showing a positional relationship between the sensor stator 13 (the base flat plate 30, excitation coil 23, sine wave coil 21, cosine wave coil 22) and the sensor rotor 12 (protrusions 12a (12aA, 12aB), recesses 12b (12bA, 12bB)) at a certain time. This relationship is actually in a circular graph, but in FIG. 9A it is illustrated in a linear graph for easy viewing.

In FIG. 9A, the electric angle represented by a lateral axis is 360° (180° in mechanical angle for a 2× coil). For convenience, furthermore, the sine wave coil 21 and the cosine wave coil 22 are illustrated as one layer and the excitation coil 23 is illustrated as a separate layer. Specifically, in FIG. 9A, the sensor stator 13 shows the excitation coil 23 on the base flat plate 30, and thereon the sine wave coil 21 and the cosine wave coil 22. The sensor rotor 12 is formed with the recesses 12b and the protrusions 12a alternately arranged in respective two sections in a range corresponding to an electric angle of 180° (a mechanical angle of 90° for the 2× coil).

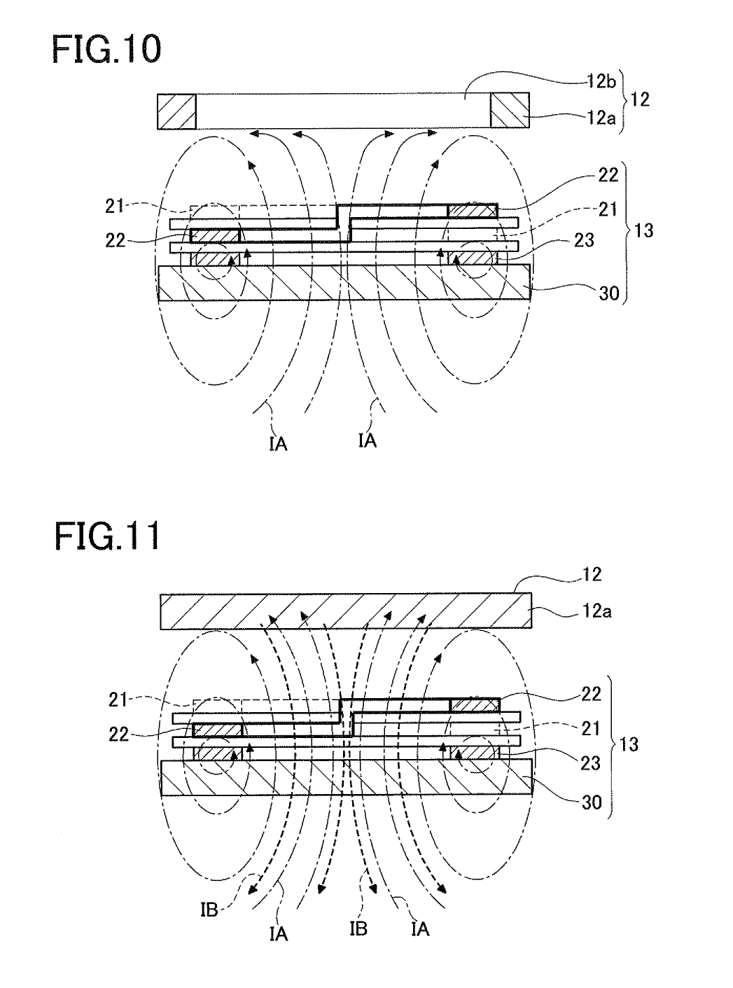

FIG. 10 is a cross sectional view showing actions of portions of the sensor rotor 12 in which the recesses 12b are provided. In FIG. 10, the excitation coil 23 is illustrated as an independent layer for convenience. In FIG. 10, when the excitation coil 23 receives, from the D/A converter 58, an excitation signal produced by amplitude modulation of the carrier wave of 500 kHz by the signal wave of 7.8125 kHz, a magnetic flux IA is generated in the excitation coil 23. By the generation of the magnetic flux IA, the sine wave coil 21 and the cosine wave coil 22 generate induced voltages.

On the other hand, FIG. 11 is a cross sectional view showing actions of portions of the sensor rotor 12 in which the protrusions 12a are provided in FIG. 9A. In FIG. 11, the excitation coil 23 is also illustrated as an independent layer for convenience. In FIG. 11, the protrusions 12a of the sensor rotor 12 face the sine wave coil 21 and the cosine wave coil 22 of the sensor stator 13. When the excitation coil 23 receives, from the D/A converter 58, an excitation signal produced by amplitude modulation of the carrier wave of 500 kHz by the signal wave of 7.8125 kHz, a magnetic flux IA is generated in the excitation coil 23 according to a current value of the excitation signal.

However, when the magnetic flux IA enter the protrusions 12a made of the non-magnetic conductive material, an eddy current is generated on the surface of each protrusion 12a. The generated eddy current causes the generation of a magnetic flux IB in an opposite direction to the magnetic flux IA as shown in FIG. 11. The magnetic flux IB cancels out the magnetic flux IA generated in the normal direction in the excitation coil 23. Thus, the magnetic fluxes as a whole practically disappear as compared with the case shown in FIG. 10.

In the state shown in FIG. 9A, therefore, it can be regarded that only the magnetic flux IA are generated in the region (from 160° to 340° in electric angle) overlapping with the recesses 12b.

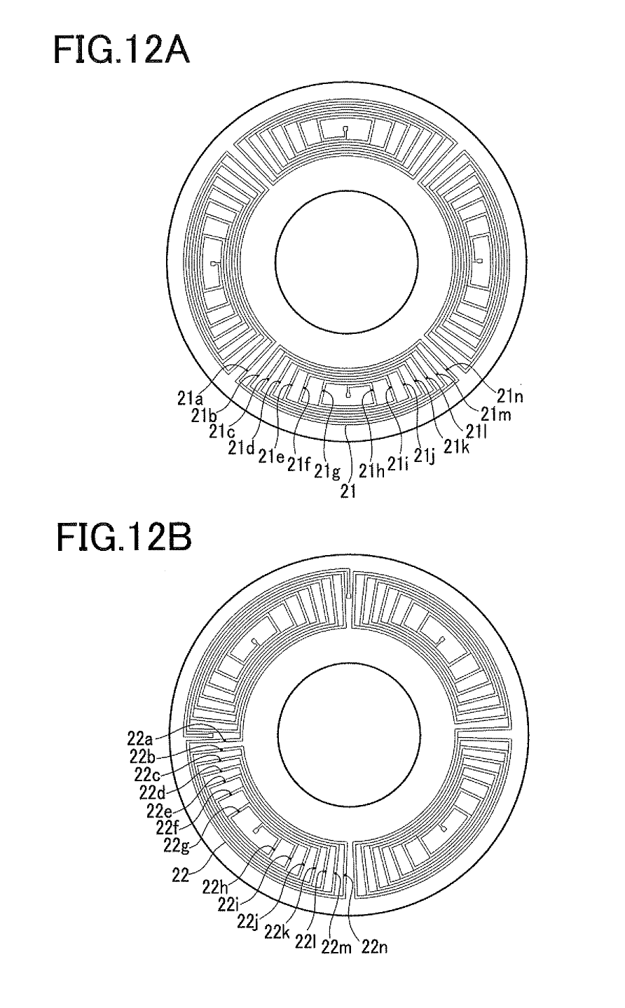

Herein, the sine wave coil 21 and the cosine wave coil 22 are explained below. FIG. 12A is a plan view showing an example of the sine wave coil 21. In this figure, the entire sine wave coil 21 is illustrated in one plane for easy viewing. As shown in FIG. 12A, each of four coil parts of the sine wave coil 21 is constituted of seven sets of coil wires 21a-21n, 21b-21m, 21c-21l, 21d-21k, 21e-21j, 21f-21i, and 21g-21h.

Similarly, FIG. 12B is a plan view showing an example of the cosine wave coil 22. In this figure, the entire cosine wave coil 22 is also illustrated in one plane for easy viewing. As shown in FIG. 12B, each of four coil parts of the cosine wave coil 22 is constituted of seven sets of coil wires 22a-22n, 22b-22m, 22c-22l, 22d-22k, 22e-22j, 22f-22i, and 22g-22h.

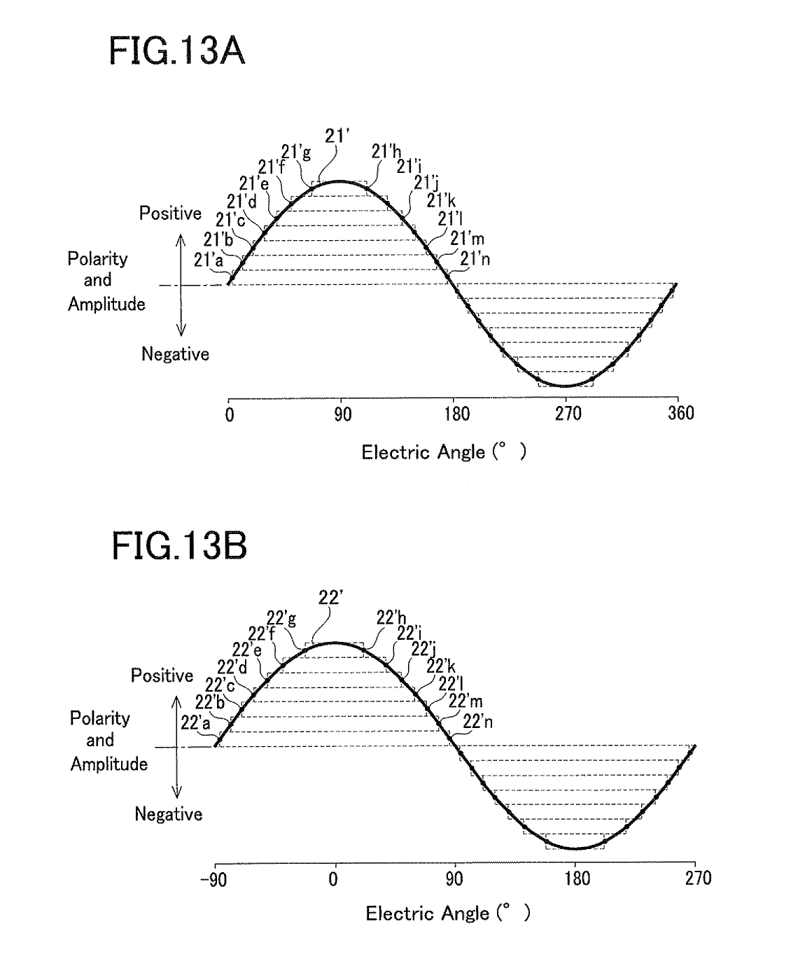

FIG. 13A is a graph showing the magnitude of induced voltage that may be generated in each set of the coil wires 21a-21n, 21b-21m, 21c-21l, 21d-21k, 21e-21j, 21f-21i, and 21g-21h when uniform magnetic fluxes are generated in the same direction in the sine wave coil 21. The magnitude is expressed in a graph including rectangles 21′a-21′n, 21′b-21′m, 21′c-21′l, 21′d-21′k, 21′e-21′j, 21′f-21′i, and 21′g-21′h. In FIG. 13A, the magnitude of induced voltage which may be generated in the entire sine wave coil 21 is represented by a waveform 21′. As above, since each coil part of the sine wave coil 21 is constituted of the seven sets of coil wires 21a-21n, 21b-21m, 21c-21l, 21d-21k, 21e-21j, 21f-21i, and 21g-21h, the induced voltage generated in the sine wave coil 21 can be expressed by an integration value in a range where the magnetic flux of a sine wave curve passes.

FIG. 13B is a graph showing the magnitude of induced voltage that may be generated in each set of the coil wires 22a-22n, 22b-22m, 22c-22l, 22d-22k, 22e-22j, 22f-22i, and 22g-22h when uniform magnetic fluxes are generated in the same direction in the cosine wave coil 22. The magnitude is expressed in a graph including rectangles 22′a-22′n, 22′b-22′m, 22′c-22′l, 22′d-22′k, 22′e-22′j, 22′f-22′i, and 22′g-22′h. In FIG. 13B, the magnitude of induced voltage which may be generated in the entire cosine wave coil 22 is represented by a waveform 22′. As above, since each coil part of the cosine wave coil 22 is constituted of the seven sets of coil wires 22a-22n, 22b-22m, 22c-22l, 22d-22k, 22e-22j, 22f-22i, and 22g-22h, the induced voltage generated in the cosine wave coil 22 can be expressed by an integration value in a range where the magnetic flux of a cosine wave curve passes.

FIG. 9B shows an induced voltage MA generated in the sine wave coil 21 and an induced voltage MB generated in the cosine wave coil 22 by the magnetic flux IA. FIG. 9C shows only the waveform 21′ shown in FIG. 9A. In the electric angle range from 160° to 180°, a positive induced voltage (+MSA1) having an area indicated by MSA1 occurs. In the electric angle range from 180° to 340°, a negative induced voltage (−MSA2) having an area indicated by MSA2 occurs. As a result, the induced voltage MA generated in the sine wave coil 21 is expressed by “MA=+MSA1−MSA2”. This is shown in FIG. 9B.

On the other hand, FIG. 9D shows only the waveform 22′ shown in FIG. 9A. In the electric angle range from 160° to 270°, a negative induced voltage (−MSB1) having an area indicated by MSB1 occurs. In the electric angle range from 270° to 340°, a positive induced voltage (+MSB2) having an area indicated by MSB2 occurs. As a result, the total induced voltage MB generated in the cosine wave coil 22 is expressed by “MB=+MSB2−MSB1”. This is shown in FIG. 9B.

The above explanation describes that the generation of the magnetic flux IA cause the generation of the induced voltages MA and MB in the sine wave coil 21 and the cosine wave coil 22 respectively. The direction and the magnitude of the magnetic flux IA periodically vary according to the phase of the excitation signal inputted in the excitation coil 23. Accordingly, the induced voltages (detection signals) generated in the sine wave coil 21 and cosine wave coil 22 also periodically vary. Herein, in the circuit section 41 shown in FIG. 3, the synchronous detectors 51 and 52 and the integration circuits 53 and 54 remove the components of the carrier waves from the above periodic components contained in the detection signals to smooth the resultant periodic components. The computing unit 60 then calculates a ratio (equal to a ratio of MA/MB of the induced voltage) between the output of the integration circuit 53 and the output of the integration circuit 54. Based on this calculated ratio, the angular displacement of the sensor rotor 12 with respect to the sensor stator 13 can be determined. The computing unit 60 outputs the above ratio as angle data 61.

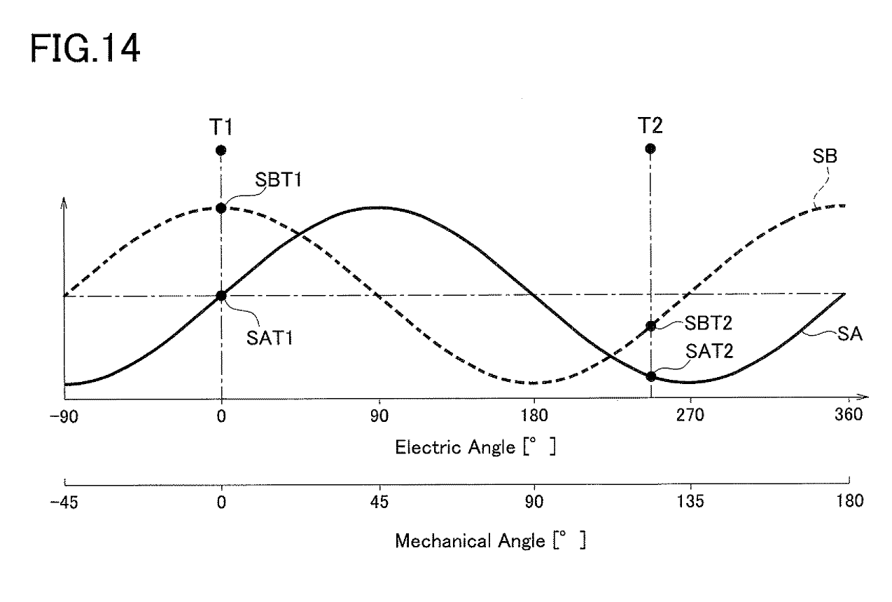

The operations of the rotation detector 11 in which the sensor rotor 12 is rotated will be explained referring to FIGS. 14 to 16.

FIG. 14 is a graph showing a relationship between an electric angle (−90° to 360°) and a mechanical angle (−45° to 180°) and each output value of the sine wave coil 21 and the cosine wave coil 22 when the magnetic fluxes IA occur in the predetermined direction. The rotation detector 11 in the present embodiment is a 2× configuration and thus the electric angle is double the mechanical angle. In FIG. 14, “SA” represents an output curve of the sine wave coil 21 and “SB” represents an output curve of the cosine wave coil 22.

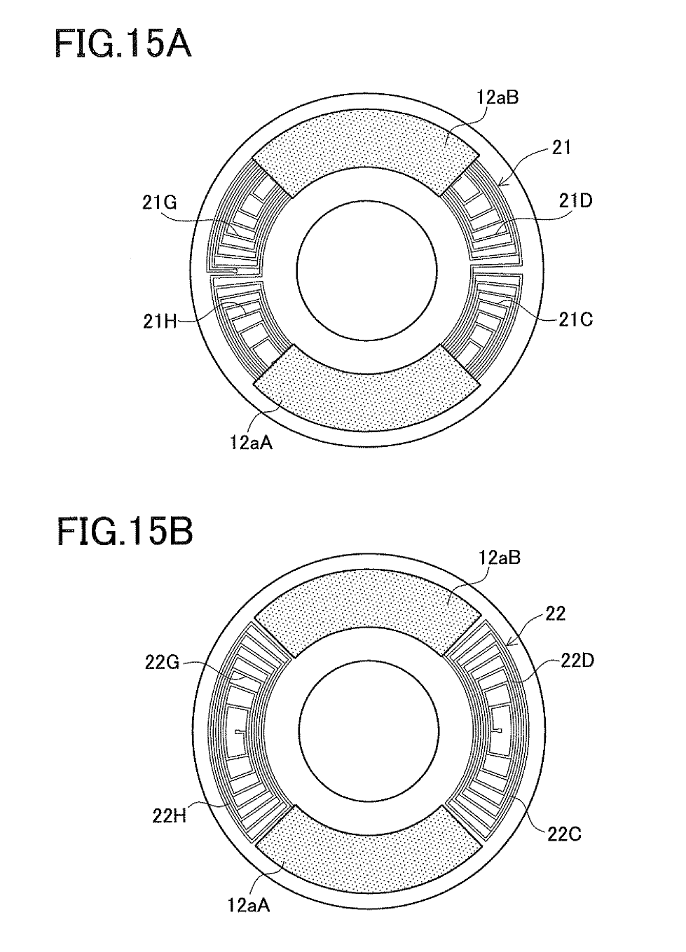

FIG. 15A is a plan view showing a positional relationship between the sine wave coil 21 and the protrusions 12a (12aA and 12aB) at a rotor angle T1 in FIG. 14. FIG. 15B is a plan view showing a positional relationship between the cosine wave coil 22 and the protrusions 12a (12aA and 12aB) at the rotor angle T1 in FIG. 14. In FIGS. 15A and 15B, for easy viewing, the sine wave coil 21 and the cosine wave coil 22 are depicted in one planes, different from FIG. 5 but similar to FIGS. 6B and 6C.

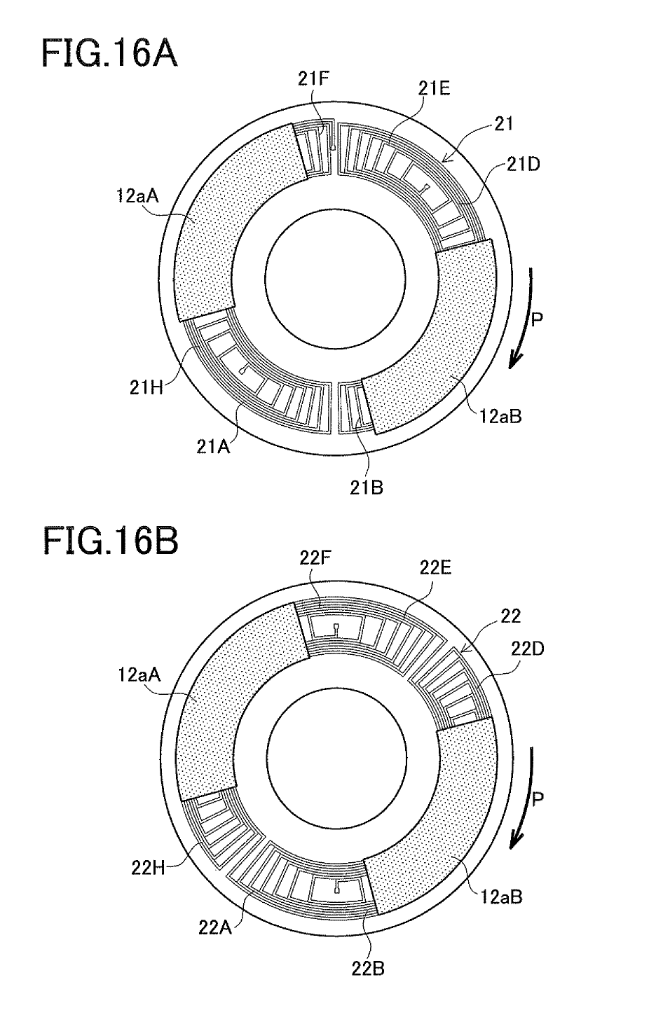

FIG. 16A is a plan view showing a positional relationship between the sine wave coil 21 and the protrusions 12a (12aA and 12aB) at a rotor angle T2 in FIG. 14. FIG. 16B is a plan view showing a positional relationship between the cosine wave coil 22 and the protrusions 12a (12aA and 12aB) at the rotor angle T2 in FIG. 14. In FIGS. 16A and 16B, for facilitating viewing, the sine wave coil 21 and the cosine wave coil 22 are depicted in one planes, different from FIG. 5 but similar to FIGS. 6B and 6C. Further, FIGS. 16A and 16B illustrate a state where the sensor rotor 12 has been rotated from the state of FIGS. 15A and 15B by an electric angle of 240° (a mechanical angle of 120°) in a direction indicated by an arrow P.

At the rotor angle T1 in FIG. 14, as shown in FIG. 15A, the entire region of each of the sine-wave split-coil segments 21C, 21D, 21G, and 21H of eight sine-wave split-coil segments 21A to 21H of the sine wave coil 21 face the recesses 12b of the sensor rotor 12. The entire region of each of the sine-wave split-coil segments 21A, 21B, 21E, and 21F face the protrusions 12a (12aA and 12aB).

The magnetic fluxes IA generated in the excitation coil 23 are uniform in the same direction over the regions. Thus, the induced voltages generated in the first sine wave coil 21BC and the second sine wave coil 21DE are equal in absolute value but opposite in direction. Similarly, the induced voltages generated in the third sine wave coil 21FG and the fourth sine wave coil 21HA are equal in absolute value but opposite in direction.

On the other hand, in the regions of the protrusions 12a (12aA and 12aB), the magnetic flux IA is canceled by the magnetic flux IB generated by the eddy current, so that no induced voltage occurs in the sine wave coil 21. Accordingly, the output value SAT1 of the sine wave coil 21 is zero in FIG. 14.

On the other hand, at the rotor angle T1 in FIG. 14, the entire region of each cosine-wave split-coil segment 22C, 22D, 22G and 22H of eight cosine-wave split-coil segments 22A to 22H of the cosine wave coil 22 face the recesses 12b (12bA and 12bB) of the sensor rotor 12 as shown in FIG. 15B. The entire region of each cosine-wave split-coil segments 22A, 22B, 22E, and 22F face the protrusions 12a (12aA and 12aB). The magnetic fluxes IA generated by the excitation coil 23 are uniform in the same direction over the regions. Thus, a maximum induced voltage occurs in the second cosine wave coil 22CD. Similarly, a maximum induced voltage occurs in the fourth cosine wave coil 22GH.

On the other hand, in the protrusions 12a (12aA, 12aB), the magnetic flux IA is canceled by the magnetic flux IB generated by the eddy current. Thus, no induced voltages occurs in the first cosine wave coil 22AB and the third cosine wave coil 22EF of the cosine wave coil 22. Accordingly, the output value SBT1 of the cosine wave coil 22 is a maximum in FIG. 14.

At the rotor angle T2 in FIG. 14, as shown in FIG. 16A, the entire region of each of the sine-wave split-coil segments 21E and 21A and a partial region of each of the sine-wave split-coil segments 21D, 21F, 21H, and 21B of eight sine-wave split-coil segments 21A to 21H face the recesses 12b (12bA, 12bB) of the sensor rotor 12. The entire region of each of the sine-wave split-coil segments 21G and 21C and a partial region of each of the sine-wave split-coil segments 21D, 21F, 21H, and 21B face the protrusions 12a (12aA and 12aB). The magnetic fluxes IA generated by the excitation coil 23 are uniform in the same direction over the regions. Thus, the induced voltages occur in opposite directions in the sine wave coil 21DE and the third sine wave coil 21FG. Similarly, the induced voltages occur in opposite directions in the fourth sine wave coil 21HA and the first sine wave coil 21BC.

On the other hand, in the regions of the protrusions 12a (12aA and 12aB), the magnetic flux IA is canceled by the magnetic flux IB generated by the eddy current, so that no induced voltage occurs in the sine wave coil 21. Accordingly, an output value SAT2 of the sine wave coil 21 is a calculated value as shown in FIG. 14.

At the rotor angle T2 in FIG. 14, as shown in FIG. 16B, the entire region of each of the cosine-wave split-coil segments 22E and 22A and a partial region of each of the cosine-wave split-coil segments 22D, 22F, 22H, and 22B of eight cosine wave cosine-wave split-coil segments 22A to 22H face the recesses 12b (12bA, 12bB) of the sensor rotor 12. The entire region of each of the cosine-wave split-coil segments 22G and 22C and a partial region of each of the cosine-wave split-coil segments 22D, 22F, 22H, and 22B face the protrusions 12a (12aA and 12aB). The magnetic fluxes IA generated by the excitation coil 23 are uniform in the same direction over the regions. Thus, the induced voltages occur in opposite directions in the second cosine wave coil 22CD and the third cosine wave coil 22EF. Similarly, the induced voltages occur in opposite directions in the fourth cosine wave coil 22GH and the first cosine wave coil 22AB.

On the other hand, in the regions of the protrusions 12a (12aA, 12aB), the magnetic flux IA is canceled by the magnetic flux IB generated by the eddy current, so that no induced voltage occurs in the cosine wave coil 22. Accordingly, the output value SBT2 of the cosine wave coil 22 is a calculated value as shown in FIG. 14.

At the rotor angle T1 in FIG. 14, the computing unit 60 shown in FIG. 3 calculates a ratio (SAT1/SBT1) between the output value SAT1 (zero) of the sine wave coil 21 and the output value SBT1 (maximum) of the cosine wave coil 22. Based on this ratio, SAT1/SBT1, an angular displacement of the sensor rotor 12 with respect to the sensor stator 13 at the rotor angle T1 can be determined. The computing unit 60 outputs the ratio, SAT1/SBT1, as the angle data 61.

Similarly, at the rotor angle T2 in FIG. 14, the computing unit 60 in FIG. 3 calculates a ratio (SAT2/SBT2) between the output value (a computed value) SAT2 of the sine wave coil 21 and the output value (a computed value) SBT2 of the cosine wave coil 22. Based on this ratio, SAT2/SBT2, the angular displacement of the sensor rotor 12 with respect to the sensor stator 113 at the rotor angle T2 can be determined. The computing unit 60 outputs the ratio, SAT2/SBT2, as the angle data 61.

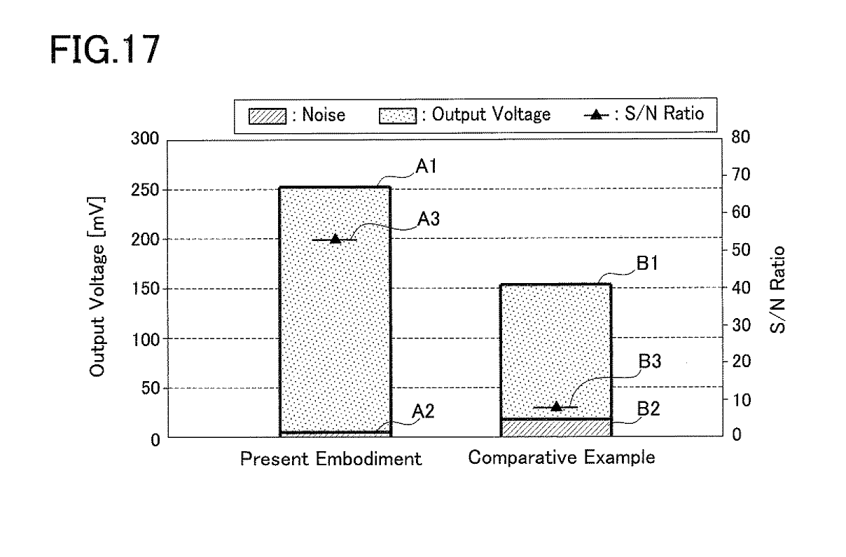

FIG. 17 is a graph showing experimental data on the rotation detector 11 in the present embodiment. In this graph, a lateral axis represents the rotation detector 11 of the present embodiment and a rotation detector of a comparative example and a vertical axis represents output voltage and S/N ratio. The rotation detector of the comparative example includes a sensor rotor made of a magnetic conductive material and formed with recesses identical to those of the rotation detector 11.

As shown in FIG. 17, the rotation detector 11 of the present embodiment provides a result that output voltage A1 is 250 mV, noise A2 is 4.5 mV, and S/N ratio A3 is about 55. The rotation detector of the comparative example provides a result that output voltage B1 is 150 mV, noise B2 is 19 mV, and S/N ratio is about 8.

The above experimental results reveal that even the rotation detector of the comparative example including the sensor rotor made of the magnetic conductive material could be practically used as a rotational angle sensor and also that the rotation detector 11 including the sensor rotor made of the nonmagnetic conductive material achieves a very high S/N ratio and excellent characteristics as a rotational angle sensor.

The rotation detector 11 of the present embodiment explained as above includes the excitation coil 23 which receives the excitation signal, the sensor stator 13 including the detection coils 32 and 34 (the sine wave coil 21 and the cosine wave coil 22) which output the motor rotor signals, and the sensor rotor 12 rotatably placed to face the sensor stator 13 in the axial direction. Further, the flat plate-like sensor stator 13 and the flat plate-like sensor rotor 12 face in parallel with each other. Therefore, the rotation detector 11 can have a reduced size in the axial direction and hence be compact.

In the present embodiment, particularly, the excitation coil 23 and the detection coils 32 and 34 constituting the sensor stator 13 use high frequency signals and thus each coil can have a reduced number of turns. Since the excitation coil 23 and the detection coils 32 and 34 are configured in flat coil patterns wound in planar shape, those coils 23, 32, and 34 are not bulky. Accordingly, the rotation detector 11 can have a reduced size in the axial direction and hence be compact.

The reason why the detection coils 32 and 34 can be made in flat coil patterns as mentioned above is that a high-frequency wave of 500 kHz is used as a carrier wave for the excitation coil 23 and this can reduce the number of turns of each detection coil 32 and 34. In other words, a signal wave of 7.8125 kHz is used because of the use of the carrier wave of such a high frequency as 500 kHz. Accordingly, the number of turns of each detection coil 32 and 34 can be reduced to as small as 7 turns. Consequently, the coil wire of each detection coil 32 and 34 can be arranged spirally into flat coil patterns on the base flat plate 30. The coil wire of each detection coil 32 and 34 can be arranged so as to output a detection signal of a sine or cosine wave form by changing a range through which a magnetic flux will pass, according to the rotation angle of the sensor rotor 12, when uniform magnetic fluxes act in the same direction.

In this embodiment, the excitation coil 23 and the first detection coil 32 which is part of one detection coil are formed in the same layer, so that the number of layers of components is smaller than the case where they are formed in separate layers. This configuration can reduce the thickness of the sensor stator 13. In this regard, the rotation detector 11 can have a reduced size in the axial direction and hence be compact. Furthermore, a manufacturing cost of the rotation detector 11 can be held down by the reduction in the number of layers of components.

In the rotation detector 11 in this embodiment, the sensor rotor 12 made of a nonmagnetic conductive material is formed with the pair of recesses 12bA and 12bB circumferentially spaced at a predetermined angular interval. Accordingly, when a magnetic field (magnetic flux IA) is generated by the excitation coil 23, the magnetic field (magnetic flux IA) of the excitation coil 23 passes through the detection coils 32 and 34 in only the regions overlapping the recesses 12bA and 12bB of the sensor rotor 12, thus generating an electromotive force (induced voltage) in the detection coils 32 and 34. On the other hand, when the magnetic field (magnetic flux IA) is generated by the excitation coil 23, the magnetic field (magnetic flux IA) impinges on the sensor rotor 12 in the regions not overlapping the recesses 12bA and 12bB, that is, in the regions overlapping the protrusions 12aA and 12aB, thus generating an eddy current on the surface of the sensor rotor 12. This eddy current causes a magnetic field (magnetic flux IB) to occur in an opposite direction to the magnetic field (magnetic flux IA) of the excitation coil 23. Thus, the magnetic fields in both directions (magnetic fluxes IA and IB) cancel each other and therefore no induced voltage will occur in the detection coils 32 and 34. By the above successive operations, an appropriate detection signal can be produced from the entire detection coils 32 and 34. In this way, the rotation detector 11 can perform rotation angle detection. Consequently, the manufacturing cost of the sensor rotor 12 can be held down, leading to a low manufacturing cost of the rotation detector 11.

In the rotation detector 11 in the present embodiment, both the excitation coil 23 and the detection coils 32 and 34 are provided in the sensor stator 13. Unlike the case where the excitation coil 23 and the detection coils 32 and 34 are provided separately in the sensor stator 13 and the sensor rotor 12, therefore, there is no need to communicate the detection signals of the detection coils 32 and 34 between the sensor rotor 12 and the sensor stator 13. Thus, no rotary transformer coil is required to communicate signals. As a result, the rotation detector 11 does not have to include a rotary transformer coil and thus can have a simplified configuration. In this regard, the rotation detector 11 can be made compact.

Since the rotation detector 11 in the present embodiment does not have to include a rotary transformer coil, it is possible to increase gain of the detection signal and also increase its S/N ratio. For instance, while a rotation detector having a rotary transformer coil provides an S/N ratio of about 4, the present embodiment can provide an S/N ratio of 50 or higher.

In the present embodiment, the detection coils 32 and 34 (the sine wave coil 21 and the cosine wave coil 22) include eight sine-wave split-coil segments 21A to 21H that are sequentially continuously arranged and eight cosine-wave split-coil segments 22A to 22H that are sequentially continuously arranged. Further, the sine-wave split-coil segments 21A, 21C, 21E, and 21G and the cosine-wave split-coil segments 22B, 22D, 22F, and 22H are formed in the same layer. The sine-wave split-coil segments 21B, 21D, 21F, and 21H and the cosine-wave split-coil segments 22A, 22C, 22E, and 22G are formed in the same layer. Those layers are placed to overlap one on the other. Accordingly, even when a gap between the sensor stator 13 and the sensor rotor 12 is slightly changed when the rotation detector 11 is mounted in the motor 1, the positional relationship between the sine wave coil 21 and the sensor rotor 12 and the positional relationship between the cosine wave coil 22 and the sensor rotor 12 can be constantly maintained. Accordingly, it is possible to reduce detection errors of rotation angle resulting from a mounting error of the rotation detector 11.

In the present embodiment, the flat coil pattern constituting the excitation coil 23 is placed along the outer circumference of the flat coil patterns in the forward direction (the forward-winding coil) and the flat coil patterns in the reverse direction (the reverse-winding coil) constituting the detection coils 32 and 34. Thus, the outer circumference sides of the detection coils 32 and 34 are applied with a uniform continuous magnetic field by the excitation coil 23. In this embodiment, particularly, the excitation coil 23 being made by annularly winding a coil wire in multiple turns can generate a uniform magnetic field over the entire circumference of the excitation coil 23. Accordingly, the excitation signal can be supplied continuously uniformly to the detection coils 32 and 34 in their circumferential direction. In this regard, the rotation detector 11 can achieve enhanced rotation angle detection accuracy.

In the present embodiment, the sensor rotor 12 of the rotation detector 11 is made of the non-magnetic conductive material. This can increase an eddy current to be generated on the surface of the sensor rotor 12 and thereby raise an efficiency of canceling the magnetic flux generated in the excitation coil 23. Accordingly, the S/N ratio becomes larger (noise becomes smaller), so that the rotation detector 11 can achieve improved rotation angle detection accuracy.

In the rotation detector 11 in this embodiment, the excitation signal produced by amplitude-modulating the carrier wave of 500 kHz with the signal wave of 7.8125 kHz for the excitation coil 23 is used to perform the angle detection. Accordingly, the carrier wave is less likely to be influenced by motor noise (most part thereof is close to 10 kHz). In this regard, the S/N ratio of the detection signal in the detection coils 32 and 34 can be enhanced.

In the present embodiment, in the detection coils 32 and 34, seven sets of the coil wires forming the sine wave coil 21; 21a-21n, 21b-21m, 21c-21l, 21d-21k, 21e-21j, 21f-21i, and 21g-21h, are arranged so that the induced voltage generated in the sine wave coil 21 corresponds to an integration value of a sine wave curve in the range through which the magnetic flux passes. Furthermore, seven sets of the coil wires forming the cosine wave coil 22; 22a-22n, 22b-22m, 22c-22l, 22d-22k, 22e-22j, 22f-22i, and 22g-22h, are arranged so that the induced voltage generated in the cosine wave coil 22 corresponds to an integration value of a cosine wave curve in the range through which the magnetic flux passes. Consequently, with the sensor rotor 12 formed with the recesses 12b, an appropriate signal can be obtained from the entire detection coils 32 and 34.

In the motor rotor 4 of the present embodiment, provided with the end plates 8A and 8B at both ends of the rotor core 6 of the motor rotor 4, the outer surface of the first end plate 8A in the axial direction is formed with protrusions and recesses (the recesses 12bA and 12bB and the protrusions 12aA and 12aB) for angle detection that are alternately arranged in a circumferential direction. The end plate 8A constitutes the sensor rotor 12. Accordingly, the motor rotor 4 does not need to additionally include a sensor rotor for angle detection having recesses and protrusions. Thus, because of omission of part of the components for the rotation detector 11, the number of components constituting the entire motor 1 equipped with rotation detector and the number of steps of manufacturing such motor 1 can be reduced.

According to the motor 1 of the present embodiment, the outer surface of the first end plate 8A in the axial direction of the motor rotor 4 is formed with the recesses and the protrusions for angle detection (the recesses 12bA and 12bB and the protrusions 12aA and 12aB). This end plate 8A constitutes the sensor rotor 12. Further, the sensor stator 13 provided with the excitation coil 23 to which a high frequency wave is inputted is placed in a position facing the recesses and the protrusions of the sensor rotor 12. Consequently, the sensor rotor 12 with the recesses and protrusions and the sensor stator 13 make up the rotation detector 11 for detecting the rotation of the motor rotor 4 and the motor shaft 5. Thus, because of omission of part of the components for the rotation detector 11, the number of components constituting the entire motor 1 equipped with rotation detector and the number of steps of manufacturing such motor 1 can be reduced.

In the present embodiment, the first end plate 8A (the sensor rotor 12) made of the non-magnetic conductive material functions to prevent leakage of a magnetic flux and to cancel out a magnetic flux of a high frequency signal inputted in the excitation coil 23 of the sensor stator 13. Thus, the sensor rotor 12 can be improved in compatibility with the sensor stator 13 including the excitation coil 23 excited by the high frequency signal.

According to the motor 1 of the present embodiment, when the high frequency signal is inputted in the excitation coil 23 of the sensor stator 13, the detection coils 32 and 34 generate and output the electromotive forces representing changes in magnetic flux that changes at positions of the recesses and the protrusions (the recesses 12bA and 12bB and the protrusions 12aA and 12aB) of the first end plate 8A. This configuration can make the sensor stator 13 output a detection signal representing the rotation angle of the motor shaft 5 and others. Thus, the rotation angle of the motor shaft 5 and others can be detected.

According to the motor 1 of the present embodiment, the high frequency signal is used for the excitation coil 23 and the detection coils 32 and 34, so that each coil can have a reduced number of turns. Since the excitation coil 23 and the detection coils 32 and 34 are configured in flat coil patterns wound in planar shape, those coils 23, 32, and 34 are not bulky. Accordingly, the rotation detector 11 can have a reduced size in the axial direction and hence be compact.

According to the motor 1 of the present embodiment, the high/low intensity of the electromotive forces outputted from the detection coils 32 and 34 of the sensor stator 13 can be achieved by the number of turns (wire portions) different in the circumferential direction in each of the forward-winding coil and the reverse-winding coil. This can simplify the shape of the first end plate 8A (the sensor rotor 12) provided with the recesses and the protrusions (the recesses 12bA and 12bB and the protrusions 12aA and 12aB). Thus, the first end plate 8A (the sensor rotor 12) with recesses and protrusions can be produced by easy processing.

According to the motor 1 of the present embodiment, the recesses and the protrusions (the recesses 12bA and 12bB and the protrusions 12aA and 12aB) of the first end plate 8A (the sensor rotor 12) are configured so that the distance from the excitation coil 23 of the sensor stator 13 varies like a sinusoidal waveform. The sensor stator 13 is configured to detect the rotation angle based on inductance changes of the excitation coil 23 and thus can be have a simpler configuration. This can simplify the structure of the rotation detector 11.

### Second Embodiment

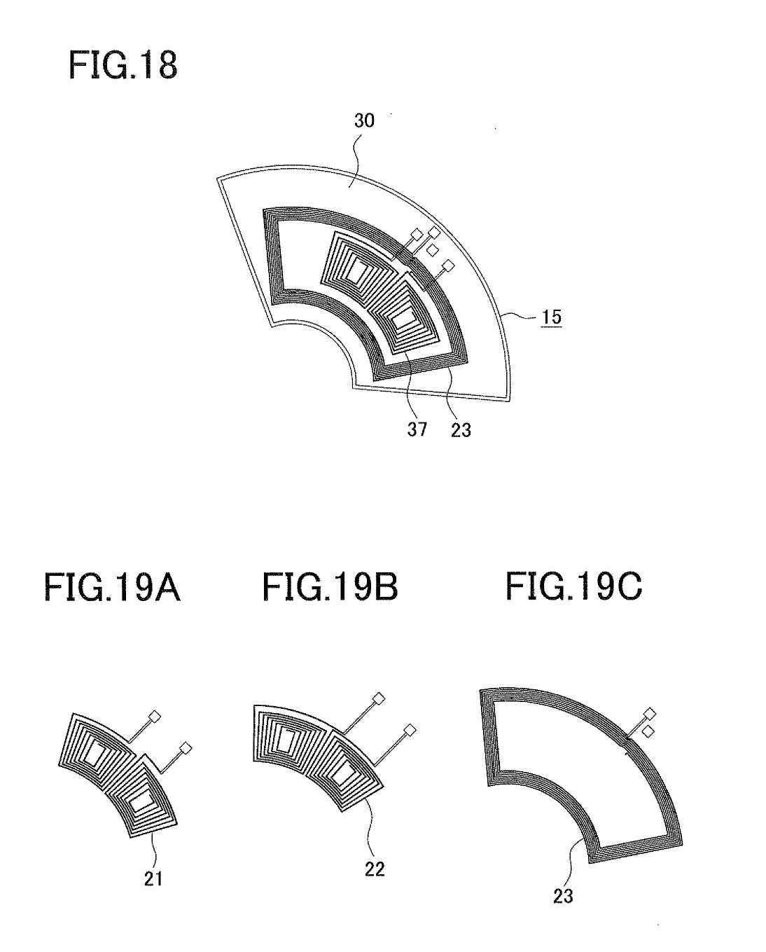

A second embodiment of the motor rotor and the motor according to the present invention will be explained below in detail referring to FIGS. 18 to 21.

In the following description, identical or similar parts to those in the first embodiment are given the same reference signs and their detailed explanations are not repeated. Thus, the following explanation is focused on differences from the first embodiment.

The present embodiment differs from the first embodiment in the configuration of the rotation detector. Firstly, the configuration of the sensor stator is explained. FIG. 18 is a plan view showing a sensor stator 15 of the present embodiment. FIGS. 19A, 19B, and 19C are plan views individually showing some of components shown in FIG. 18. In the present embodiment, the sensor stator 15 is formed to be about one-quarter the size of the sensor stator 13 of the first embodiment. Specifically, as shown in FIG. 18, a base flat plate 30 is formed in a fan-like shape, on which a detection coil 37 and an excitation coil 23 are laminated. FIGS. 19A and 19B are plan views individually showing a sine wave coil 21 and a cosine wave coil 22 that make up the detection coil 37. FIG. 19C is a plan view showing the excitation coil 23. This sensor stator 15 is mounted inside the motor case 2 as in the first embodiment.

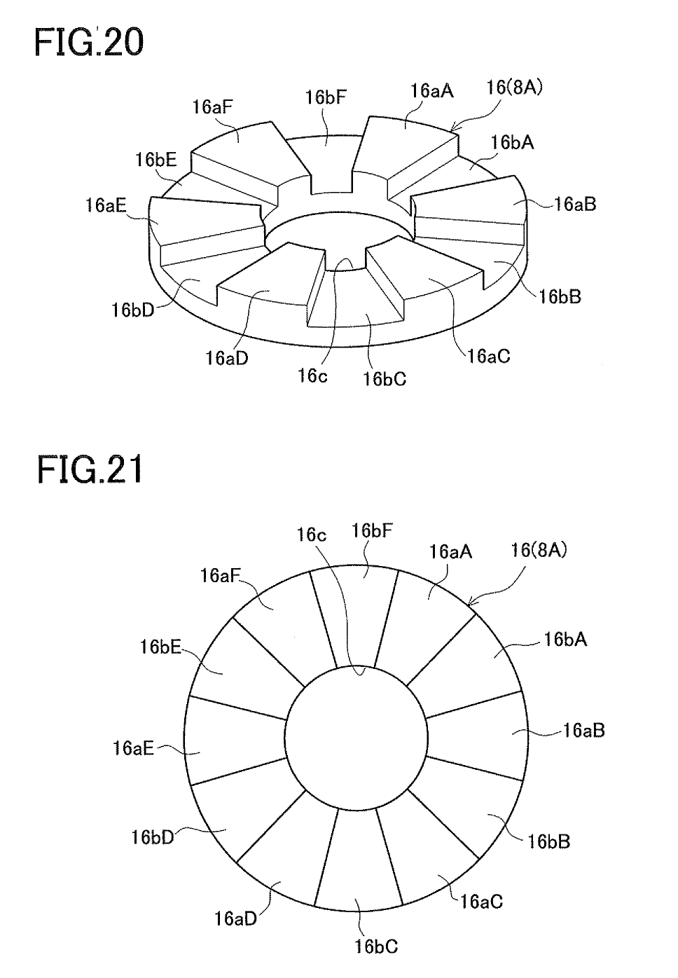

Secondly, the configuration of the sensor rotor is explained. FIG. 20 is a perspective view of a sensor rotor 16. FIG. 21 is a plan view of the sensor rotor 16. The sensor rotor 16 consisting of the first end plate 8A is made of a non-magnetic conductive material such as “SUS305 (JIS)”, which is a non-magnetic substance. The sensor rotor 16 is provided, on its an outer surface (an upper surface in FIG. 20) in an axial direction, with recesses and protrusions for angle detection alternately arranged in a circumferential direction. Those recesses and protrusions are defined by circumferential surfaces and vertical surfaces to the circumferential direction. Specifically, the sensor rotor 16 is provided with protrusions 16aA, 16aB, 16aC, 16aD, 16aE, and 16aF in six sections of the outer surface of a circular flat plate and recesses 16bA, 16bB, 16bC, 16bD, 16bE, and 16bF in other six sections. The protrusions 16aA to 16aF in the six sections and the recesses 16bA to 16bF in the six sections are located at angular intervals of 30°. In other words, in the sensor rotor 16, the recesses 16bA to 16bF are formed at a predetermined angular interval (herein, at an angular interval of 60°) in the circumferential direction. In the present embodiment, when the maximum thickness of the sensor rotor 16 is assumed to for example 10 mm, the height of each protrusion 16aA to 16aF can be set to for example about 2 mm to 3 mm.

In the sensor rotor 16 including twelve sections divided at 30° intervals, the sections being diametrically opposite in pairs, the recesses 16bA to 16bF are arranged in six sections and the protrusions 16aA to 16aF are arranged in other six sections. Each of the sine wave coil 21 and the cosine wave coil 22 of the sensor stator 15 is divided in half by 30°, so that a 6× detection coil 37 is made up.

The sensor rotor 16 is press-fitted on the outer periphery of the motor shaft 5 inserted in a center hole 16c formed at the center of the sensor rotor 16, while the sensor rotor 16 is fixed as serving as the first end plate 8A to an end face of the rotor core 6.

The sensor rotor 16 in the present embodiment is made of a material “SUS305” but may be made of a different material such as “SUS304”, aluminum, and brass, as long as the material is a non-magnetic conductive material.

According to the motor rotor 4 of the present embodiment, the recesses and the protrusions (the recesses 16bA to 16bF and the protrusions 16aA to 16aF) for angle detection alternately arranged in the circumferential direction are provided on the outer surface of the first end plate 8A in the axial direction, provided at one end of the rotor core 6 of the motor rotor 4. The end plate 8A constitutes the sensor rotor 16. Accordingly, the motor rotor 4 does not need to additionally include a sensor rotor for angle detection having recesses and protrusions. Thus, because of omission of part of the components for the rotation detector, the number of components constituting the entire motor 1 equipped with rotation detector and the number of steps of manufacturing such motor 1 can be reduced.

In the present embodiment, furthermore, the sensor stator 15 is about one-quarter the size of the sensor stator 13 of the first embodiment and thus can improve its mounting ease with respect to the motor case 2 by just that much. The entire rotation detector can therefore be made more compact.

### Third Embodiment

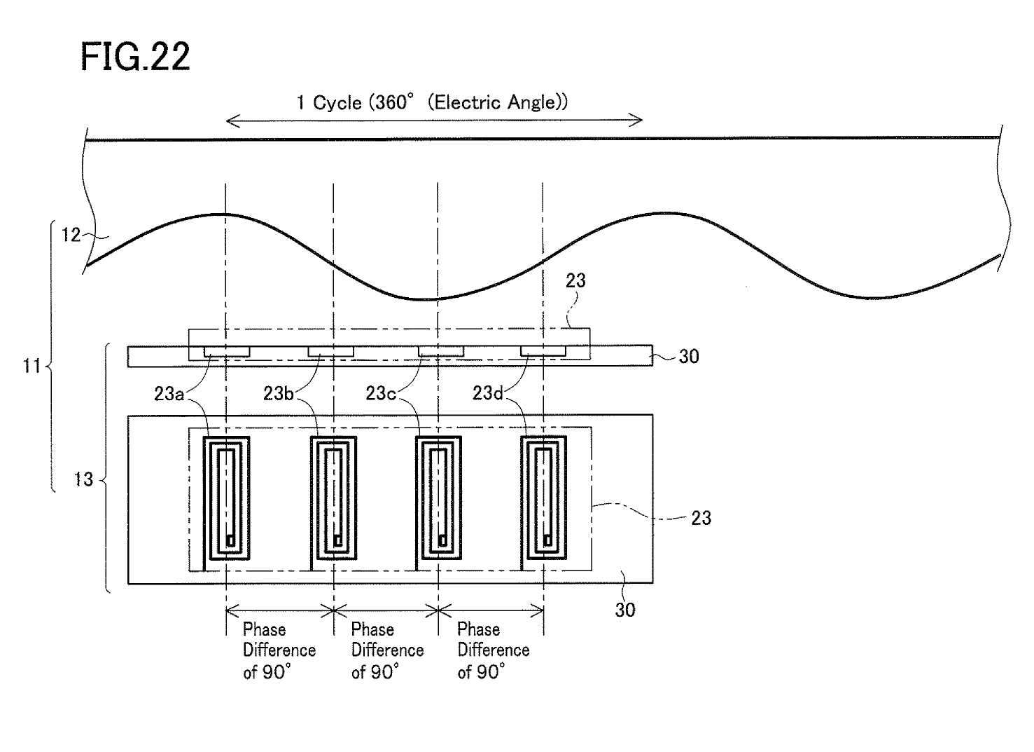

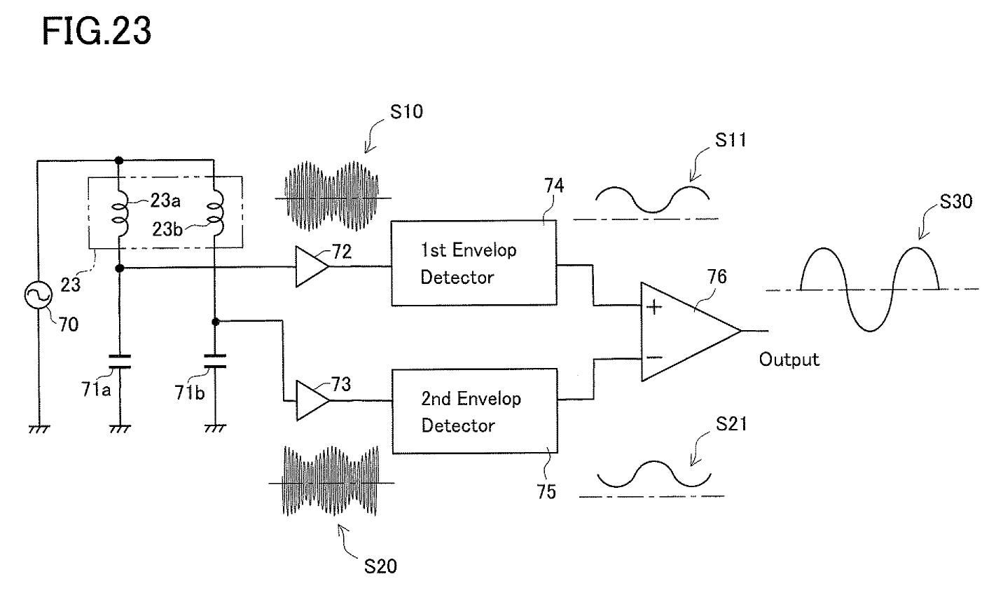

A third embodiment of the motor rotor and the motor according to the present invention will be explained in detail referring to FIGS. 22 and 23.

The present embodiment differs from the first embodiment in the configuration of the rotation detector. FIG. 22 is a conceptual diagram showing a developed configuration of the rotation detector 11. In this embodiment, unlike the first embodiment, the sensor stator 13 does not include any detection coils but does include only an excitation coil 23. Specifically, as shown in FIG. 22, the sensor stator 13 placed to face the sensor rotor 12 includes a base flat plate 30 and the excitation coil 23 formed on this plate 30. The excitation coil 23 consists of a first SIN-phase coil 23a, a first COS-phase coil 23b, a second SIN-phase coil 23c, and a second COS-phase coil 23d. The coils 23a to 23d are identical to each other in configuration. The coils 23a to 23d are arranged with a phase difference of 90° between adjacent two. On the other hand, in the sensor rotor 12, the recesses and the protrusions are formed on the surface of the sensor rotor 12 so that the distance from the excitation coil 23 changes continuously and periodically. The sensor stator 13 is configured to detect the rotation angle of the motor rotor 4 and the motor shaft 5 based on the inductance change of the excitation coil 23 in association with the rotation of the sensor rotor 12 rotated together with the motor rotor 4.

FIG. 23 is a block diagram showing a circuit configuration of the rotation detector 11. When an alternating voltage is applied from an excitation circuit 70 to the first SIN-phase coil 23a and the first COS-phase coil 23b connected in series to condensers 71a and 71b respectively, signals S10 and S20 different according to the inductance changes of the coils 23a and 23b are outputted. Those outputted signals S10 and S20 are amplified by a first amplifier 72 and a second amplifier 73 respectively. Those signals S10 and S20 are outputted with varying amplitudes and with phases different by 180°. The signals amplified by the amplifiers 72 and 73 are detected by a first envelop detector 74 and a second envelop detector 75 respectively and outputted as different detection signals S11 and S21. The detection signals S11 and S21 outputted as above are amplified by a differential amplifier 76 to be outputted as a full-wave signal S30. Based on this full-wave signal S30, the rotation angle of the motor shaft 5 can be detected.

In the present embodiment, therefore, the sensor stator 13 does not need to include any detection coils. This can achieve more simplified configuration of the sensor stator 13 in addition to the advantageous operations and effects provided in the first embodiment.

### Fourth Embodiment

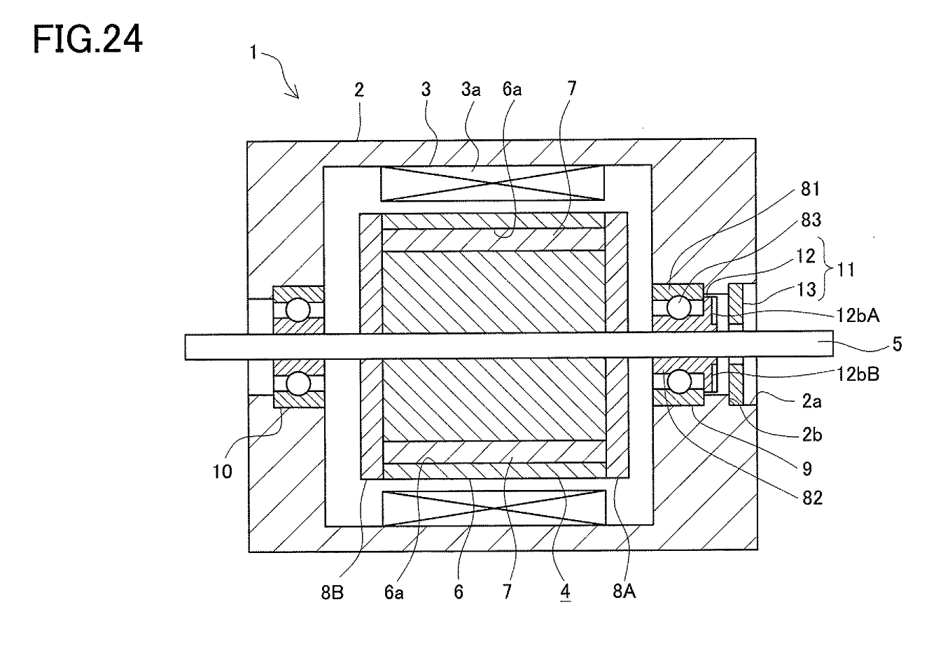

A fourth embodiment of the motor rotor and the motor according to the present invention will be explained in detail referring to FIGS. 24 to 26.

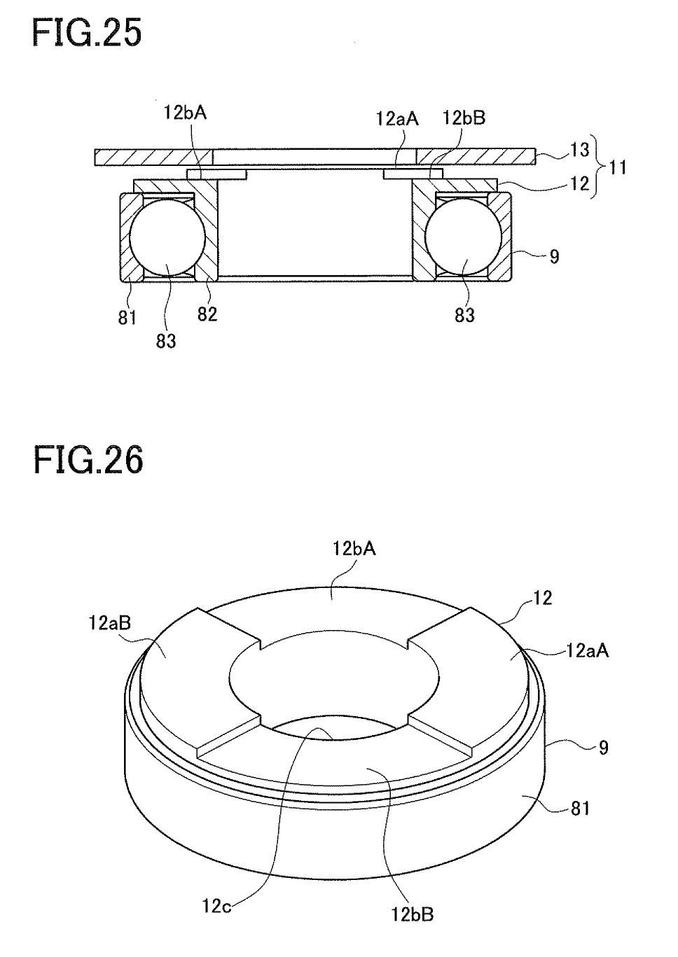

The present embodiment differs from each of the aforementioned embodiments in the configuration of the rotation detector. FIG. 24 is a cross-sectional view of a motor 1 equipped with rotation detector. FIG. 25 is an enlarged cross-sectional view of a rotation detector 11. FIG. 26 is an enlarged perspective view of a bearing 9. In the present embodiment, as shown in FIG. 24, the rotation detector 11 is provided in correspondence with the bearing 9 placed at one end of the motor 1. In other words, the sensor rotor 12 is integrally provided with the bearing 9. The sensor stator 13 is mounted in the motor case 2 so as to face the sensor rotor 12 with a predetermined gap therefrom. The motor case 2 is formed with a center hole 2a for the bearing 9 and the motor shaft 5. The sensor stator 13 is fixed to a shoulder 2b in the center hole 2a. In the present embodiment, the motor shaft 5 is placed to penetrate through the sensor rotor 12 and the sensor stator 13.

As shown in FIGS. 25 and 26, the sensor rotor 12 is integrally formed with components constituting the bearing 9. The bearing 9 includes an outer ring 81 and an inner ring 82, and a plurality of balls 83 held between the rings 81 and 82. The sensor rotor 12 is formed in a flange shape integrally at one end of the inner ring 82. Accordingly, when the inner ring 82 of the bearing 9 is rotated together with the motor shaft 5, the sensor rotor 12 is also rotated together. This rotation of the sensor rotor 12 is detected by the sensor stator 13,

As shown in FIGS. 25 and 26, the sensor rotor 12 is provided, on an outer surface in the axial direction, with recesses and protrusions for angle detection alternately arranged in a circumferential direction, as in the first embodiment. Those recesses and protrusions are defined by circumferential surfaces of the sensor rotor 12 and vertical surfaces to the circumferential direction. Specifically, the sensor rotor 12 is provided with protrusions 12aA and 12aB in two sections of the outer surface of a circular flat plate and recesses 12bA and 12bB in other two sections. The protrusions 12aA and 12aB in the two diametrically opposite sections and the recesses 12bA and 12bB in the two diametrically opposite sections are located at angular intervals of 90° from adjacent ones. In other words, in the sensor rotor 12, the recesses 12bA and 12bB are formed at a predetermined angular interval (herein, at an angular interval of 180°) in the circumferential direction.

According to the motor 1 of the present embodiment, the sensor rotor 12 is integrally provided at one end of the inner ring 82 of the bearing 9 and the outer surface in the axial direction is formed with the recesses and the protrusions (the recesses 12bA and 12bB and the protrusions 12aA and 12aB) for angle detection alternately arranged in the circumferential direction. Thus, the motor 1 does not need to additionally include any sensor rotor with recesses and protrusions for angle detection. Thus, because of omission of part of the components for the rotation detector, the number of components constituting the entire motor 1 equipped with rotation detector and the number of steps of manufacturing such motor 1 can be reduced.

### Fifth Embodiment

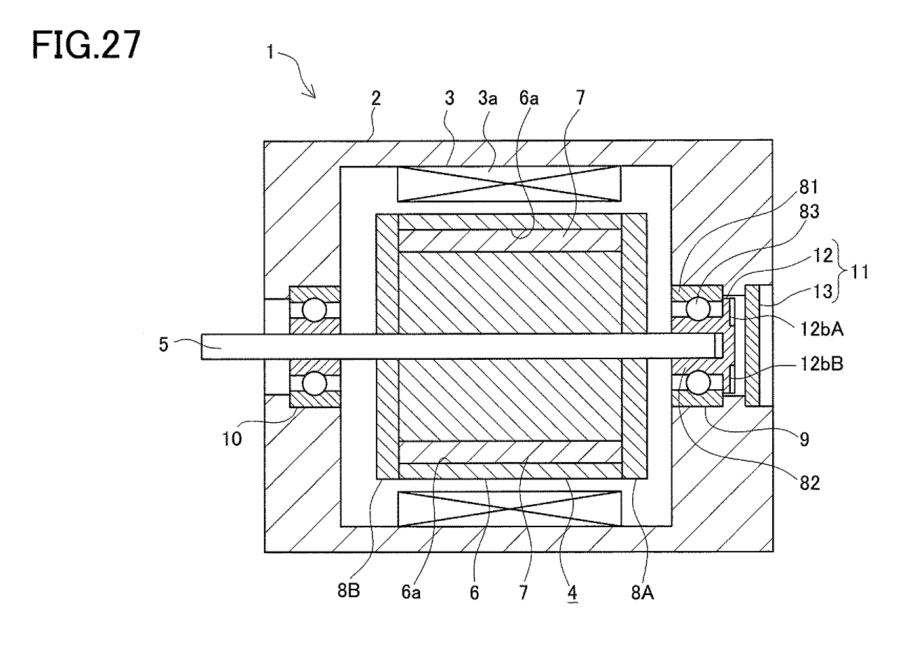

A fifth embodiment of the motor rotor and the motor according to the present invention will be explained in detail referring to FIG. 27.

This embodiment differs from the fourth embodiment in the relationship between the rotation detector 11 and the motor shaft 5. FIG. 27 is a cross-sectional view of a motor 1 with rotation detector. In the present embodiment, the motor shaft 5 is placed so as not to penetrate through the sensor rotor 12 and the sensor stator 13. Specifically, the sensor rotor 12 and the sensor stator 13 are not formed with center holes, and one end of the motor shaft 5 is received in the inner ring 82 of the bearing 9.

The present embodiment is applicable to such a motor 1 as being configured such that the motor shaft 5 protrudes only at one end side of the motor case 2.

### Sixth Embodiment

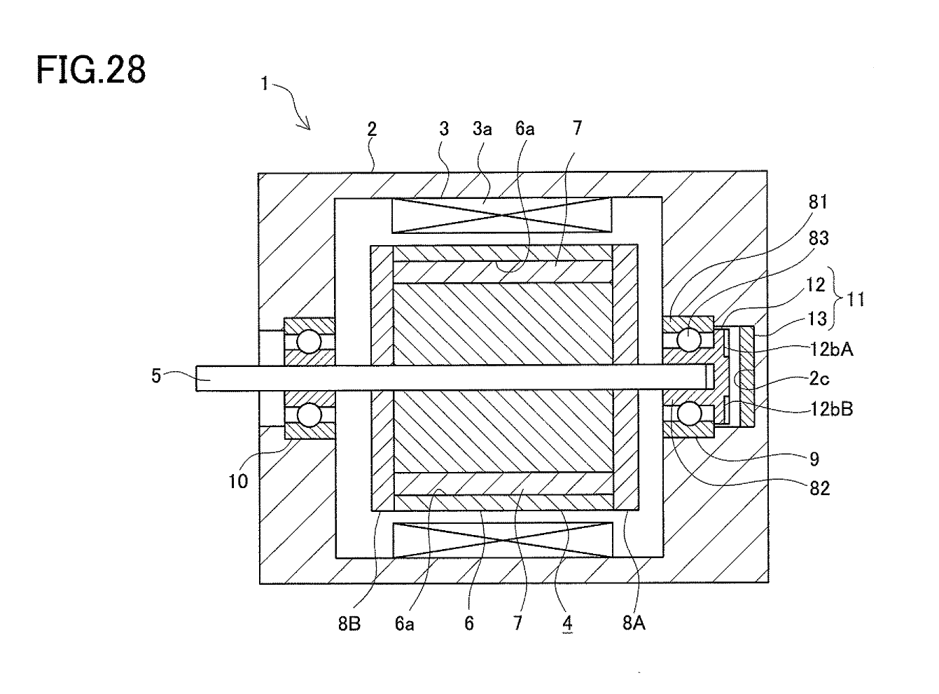

A sixth embodiment of the motor rotor and motor according to the present invention will be explained in detail referring to FIG. 28.

The present embodiment differs from the fifth embodiment in the relationship between the sensor stator 13 and the motor case 2. FIG. 28 is a cross-sectional view of a motor 1 with rotation detector. In the present embodiment, a center recess 2c is formed in one end of the motor case 2 in correspondence with the bearing 9. The sensor stator 13 is fitted in this center recess 2c and fixed to a bottom wall thereof.

In the present embodiment, the rotation detector 11 can be effectively applied to such a motor 1 including a motor case 2 with a closed one end.

The present invention is not limited to the above embodiments and may be embodied in other specific forms without departing from the essential characteristics thereof.

### INDUSTRIAL APPLICABILITY

The present invention can be utilized to manufacture of a motor with rotation detector.

### DESCRIPTION OF THE REFERENCE SIGNS

1 Motor

3 Motor stator

3a Coil

4 Motor rotor

5 Motor shaft (Rotary shaft)

6 Rotor core (Central iron core)

6a Through hole

7 Permanent magnet

8A First end plate

8B Second end plate

11 Rotation detector

12 Sensor rotor

12a Protrusion

12b Recess

12aA Protrusion

12aB Protrusion

12bA Recess

12bB Recess

13 Sensor stator

15 Sensor stator

16 Sensor rotor

16aA Protrusion

16aB Protrusion

16aC Protrusion

16aD Protrusion

16aE Protrusion

16aF Protrusion

16bA Recess

16bB Recess

16bC Recess

16bD Recess

16bE Recess

16bF Recess

23 Excitation coil

32 First detection coil

34 Second detection coil

37 Detection coil

1. A motor rotor comprising:
a rotary shaft;
a core part placed around the rotary shaft and provided with a plurality of through holes each extending in an axial direction;
a plurality of permanent magnets individually mounted in the through holes; and
a pair of end plates provided on both ends of the core part to close openings of the through holes,
wherein the end plates are made of a non-magnetic substance, and at least one of the end plates has an outer surface in an axial direction provided with recesses and protrusions for angle detection alternately arranged in a circumferential direction.

2. A motor including the motor rotor according to claim I and a motor stator including a coil,
wherein the motor comprises a detector including an excitation coil to which a high frequency signal is inputted, the detector being placed in a position to face the recesses and the protrusions of the outer surface of the end plate of the motor rotor in the axial direction.

3. The motor according to claim 2, wherein the detector further includes a detection coil, and the detection coil outputs a change in magnetic flux changing at a position of the recesses and protrusions as an electromotive force when the high frequency signal is inputted to the excitation coil.

4. The motor according to claim 3, wherein the excitation coil and the detection coil are coils wound in planar shape.

5. The motor according to claim 4, wherein
the recesses and protrusions are defined by circumferential surfaces and vertical surfaces to the circumferential direction,
the detection coil includes a forward-winding coil wound in a forward direction and a reverse-winding coil wound in a reverse direction, the coils being arranged adjacently in the circumferential direction,
a total of a width of the forward-winding coil and a width of the reverse-winding coil is approximately equal to one cycle of the recesses and protrusions, and
each of the forward-winding coil and the reverse-winding coil is a coil wound in multiple turns, the coils being arranged so that the number of turns in each coil changes in a circumferential direction by increasing and decreasing like a sinusoidal waveform.

6. The motor according to claim 2, wherein the recesses and protrusions of the end plate are configured so that a distance from the excitation coil changes periodically, and the detector detects an angle based on an inductance change of the excitation coil.
